(19) United States
(12) Patent Application Publication
(10) Pub. No.: US 2022/0212634 A1
(43) Pub. Date: Jul. 7, 2022

(54) VIEWING DEVICE FOR VEHICLE

(71) Applicant: KABUSHIKI KAISHA TOKAI-RIKA-DENKI-SEISAKUSHO, Niwa-gun, Aichi-ken (JP)

(72) Inventors: Toshiya ITO, Niwa-gun, Aichi-ken (JP); Ryusuke SADAMATSU, Niwa-gun, Aichi-ken (JP)

(21) Appl. No.: 17/610,564

(22) PCT Filed: Apr. 15, 2020
(86) PCT No.: PCT/JP2020/016496

§ 371 Date: Nov. 11, 2021

(30) Foreign Application Priority Data
May 20, 2019 (JP) 2019-094673
May 20, 2019 (JP) 2019-094678

(51) Int. Cl. B60S 1/56; B60S 1/52; B60R 1/22; G02B 27/00; B08B 3/02; B05B 15/70

(52) U.S. Cl. CPC B60S 1/56; B60S 1/52; B05B 15/70; G02B 27/0006; B08B 3/024; B60R 1/22

(57) ABSTRACT

A viewing device for a vehicle includes a viewing assistance portion configured to assist viewing by an occupant of the vehicle. A housing body houses the viewing assistance portion. An opening portion is formed in a panel member to penetrate at a peripheral portion of a main surface side of the viewing assistance portion. A nozzle in the housing body is displaceable to project/retract from the opening portion. When projecting from the opening portion, the nozzle is configured to direct washing liquid from a jetting port at a distal end portion side of the nozzle toward the main surface side of the viewing assistance portion. A cover is displaceable between a closing position and an opening position. A mechanism is operable, using a force of the nozzle being displaced, to displace the cover.

### TECHNICAL FIELD

The present disclosure relates to a viewing device for a vehicle.

### BACKGROUND ART

An onboard optical sensor washing device is disclosed in Japanese Patent Application Laid-Open (JP-A) No. 2018-34646 for example. In this device, a movable nozzle is made able to project/retract. When an operation switch is operated, the movable nozzle advances, and a mixed fluid of gas and liquid is jetted toward a lens surface from a jetting port at the distal end of the movable nozzle. Due thereto, dried mud and the like that are stuck on the lens surface are washed-off, and the lens surface is washed.

### SUMMARY OF INVENTION

### Technical Problem

By the way, there is a structure in which an opening portion is formed so as to penetrate a panel member of a vehicle at the region where a movable nozzle such as that described above is projected/retracted, and a cover covers this opening portion so as to open/close. Such a structure is structured such that, for example, the cover is displaced together with the movable nozzle, and the movable nozzle can be covered by the cover at the time when the cover is closed.

However, in such a structure, when the movable nozzle projects-out at the time of washing the main surface side of a viewing assistance portion such as a camera or a mirror or the like for example, the cover also is displaced together with the movable nozzle, and therefore, there is room for improvement with regard to the point of preventing or suppressing the cover being imaged by the viewing assistance portion.

Further, in the case of employing a structure that simply moves a nozzle, whose intermediate portion is bent such that the nozzle is L-shaped or the like for example, such that the nozzle advances/withdraws, the space at the periphery of the nozzle storage position must be made to be large in order for the distal end portion side of the nozzle to not interfere with peripheral structures at the time when the nozzle moves so as to advance/withdraw. Namely, in a case in which an attempt is made to avoid interference between the distal end portion side of the nozzle and peripheral structures at further toward the nozzle advancing direction side than the nozzle storage position, the nozzle storage position itself is shifted, but, in such a structure, the space at the periphery of the nozzle storage position must be made to be large. However, there are cases in which it difficult to make the space, which is needed to accommodate and move the nozzle, large.

The present disclosure provides a viewing device for a vehicle that can prevent or suppress a cover being imaged by a viewing assistance portion at the time of cleaning the main surface side of the viewing assistance portion.

Further, the present disclosure provides a viewing device for a vehicle that can keep the space needed for housing and moving a nozzle small, even in a case in which an intermediate portion of the nozzle is bent.

### Solution to Problem

A viewing device for a vehicle of a first aspect of the present disclosure comprises: a viewing assistance portion provided at a vehicle and configured to assist viewing by an occupant of the vehicle; a panel member configuring a portion of a housing body that houses the viewing assistance portion, and in which an opening portion for nozzle projection/retraction is formed so as to penetrate at a peripheral portion of a main surface side of the viewing assistance portion; a nozzle that is housed in the housing body and is displaced so as to project/retract from the opening portion, and that, in a state of projecting-out from the opening portion, jets washing liquid from a jetting port at a distal end portion side of the nozzle toward a main surface side of the viewing assistance portion; a cover that is displaced between a closing position at which the opening portion is closed and an opening position that is provided at a side that is farther from a main surface of the viewing assistance portion than the closing position, to perform opening and closing; and a mechanism that, using a force of the nozzle being displaced, displaces the cover in a different direction from a direction in which the nozzle is displaced so as to open/close the cover.

In accordance with the viewing device for a vehicle of the first aspect of the present disclosure, viewing by an occupant of a vehicle is assisted by the viewing assistance portion. Further, an opening portion is formed in the panel member so as to penetrate; at a peripheral portion of the main surface side of the viewing assistance portion, and the nozzle can project/retract from the opening portion. In a state of projecting-out from the opening portion, the nozzle jets washing liquid out from a jetting port at a distal end portion side of the nozzle toward the main surface side of the viewing assistance portion. Here, the cover can open/close between a closing position at which the opening portion, and an opening position that is provided at a side that is farther from the main surface of the viewing assistance portion than the closing position, to perform opening and closing. The viewing device for a vehicle has a mechanism that, using the force of the nozzle being displaced, displaces the cover in a different direction from the direction in which the nozzle is displaced so as to open/close the cover. In this way, in a case of opening the opening portion, the cover is displaced to the side far from the main surface of the viewing assistance portion, and in a different direction from the direction in which the nozzle is displaced. Therefore, the cover being imaged by the viewing assistance portion is prevented or suppressed, while the degrees of freedom in designing the displacing of the cover are ensured.

In a viewing device for a vehicle of a second aspect of the present disclosure, in the viewing device for a vehicle of the first aspect of the present disclosure, the mechanism is an interlocking mechanism configured to slide the cover from the closing position to the opening position by using force of the nozzle advancing to a position projecting out from the opening portion.

In accordance with the viewing device for a vehicle of the second aspect of the present disclosure, the interlocking mechanism slides the cover from the closing position to the opening position, by using the force of the nozzle advancing to the position projecting out from the opening portion. In this way, in a case of opening the opening portion, the cover is slid to the side far from the main surface of the viewing assistance portion, and therefore, the cover being imaged by the viewing assistance portion is prevented or suppressed.

In a viewing device for a vehicle of a third aspect of the present disclosure, in the viewing device for a vehicle of the second aspect of the present disclosure, the interlocking mechanism connects the nozzle and the cover, and also has a function of sliding the cover from the opening position to the closing position by using force of the nozzle, which is in a state of projecting-out from the opening portion, retracting.

In accordance with the viewing device for a vehicle of the third aspect of the present disclosure, the interlocking mechanism connects the nozzle and the cover. In a case in which nozzle, which is in a state of projecting-out from the opening portion, withdraws, the interlocking mechanism, by using this force, can also slide the cover from the opening position to the closing position. Namely, the interlocking mechanism can open/close the cover by using the motive power that projects/retracts the nozzle.

In a viewing device for a vehicle of a fourth aspect of the present disclosure, the viewing device for a vehicle of the second aspect of the present disclosure comprises an urging member that urges the cover in a direction of the closing position.

In accordance with the viewing device for a vehicle of the fourth aspect of the present disclosure, the cover is urged in the direction of the closing position by the urging member. Therefore, when the nozzle, which is in a state of projecting-out from the opening portion, withdraws, the cover is closed by the urging force of the urging member.

In a viewing device for a vehicle of a fifth aspect of the present disclosure, in the viewing device for a vehicle of the third aspect of the present disclosure, the interlocking mechanism comprises: a shaft portion provided at the cover; and a guiding portion provided at the nozzle, and guiding the shaft portion such that the cover slides and is opened/closed in accordance with movement of the nozzle in a projecting/retracting direction.

In accordance with the viewing device for a vehicle of the fifth aspect of the present disclosure, the guiding portion that is provided at the nozzle guides the shaft portion that is provided at the cover, such that the cover slides and is opened/closed in accordance with the movement of the nozzle in the projecting/retracting direction. Accordingly, without making the structure complex, the cover can be opened/closed by using the motive power that that projects/retracts the nozzle.

In a viewing device for a vehicle of a sixth aspect of the present disclosure, in the viewing device for a vehicle of the third aspect of the present disclosure, the interlocking mechanism comprises: a shaft portion provided at the nozzle; and a guiding portion provided at the cover, and guiding the shaft portion, and is configured to slide and open/close the cover by receiving load from the shaft portion in accordance with movement of the nozzle in a projecting/retracting direction.

In accordance with the viewing device for a vehicle of the sixth aspect of the present disclosure, the guiding portion that is provided at the cover guides the shaft portion that is provided at the nozzle, and slides and opens/closes the cover by receiving load from the shaft portion in accordance with the movement of the nozzle in the projecting/retracting direction. Accordingly, without making the structure complex, the cover can be opened/closed by using the motive power that projects/retracts the nozzle.

In a viewing device for a vehicle of a seventh aspect of the present disclosure, in the viewing device for a vehicle of the first aspect of the present disclosure, the mechanism is a rotating mechanism configured to rotate and displace the nozzle around an axis of a proximal portion, a bent portion is formed at an intermediate portion of the nozzle, and the nozzle is disposed such that the jetting port faces the main surface side of the viewing assistance portion as a result of the nozzle being rotated and displaced, by the rotating mechanism, around the axis of the proximal portion that is further toward a proximal end side than the bent portion, and the cover is rotated and displaced from the closing position to the opening position by the rotating mechanism by using a force of the nozzle being rotated and displaced.

In accordance with the viewing device for a vehicle of the seventh aspect of the present disclosure, a bent portion is formed at an intermediate portion of the nozzle, and the nozzle is rotated and displaced around the axis of the proximal portion by the rotating mechanism. The jetting port is disposed so as to face the main surface side of the viewing assistance portion, as a result of the nozzle being rotated and displaced around the axis of the proximal portion, which is further toward the proximal end side than the bent portion, by the rotating mechanism. Due thereto, for example, even in a case in which it is desired to employ peripheral structures that are interfered with by a portion of the distal end portion side of the nozzle when the nozzle is moved so as to merely advance/withdraw, the nozzle can be projected-out from the opening portion while avoiding peripheral structural portions that will interfere in this way.

In a viewing device for a vehicle of an eighth aspect of the present disclosure, in the viewing device for a vehicle of the seventh aspect of the present disclosure, an advancing/withdrawing mechanism that moves the nozzle so as to advance/withdraw along an axial direction of the proximal portion.

In accordance with the viewing device for a vehicle of the eighth aspect of the present disclosure, the nozzle is moved so as to advance/withdraw along the axial direction of the proximal portion by the advancing/withdrawing mechanism. Due thereto, the number of variations of the locus of movement of the nozzle can be increased, and therefore, the number of variations for avoiding interference between the nozzle and peripheral structures can be increased.

In a viewing device for a vehicle of a ninth aspect of the present disclosure, in the viewing device for a vehicle of the eighth aspect of the present disclosure, the rotating mechanism is an advancing/withdrawing rotating mechanism that also serves as the advancing/withdrawing mechanism and configured to rotate and displace the nozzle around the axis of the proximal portion while moving the nozzle to advance/withdraw along the axial direction of the proximal portion.

In accordance with the viewing device for a vehicle of the ninth aspect of the present disclosure, the rotating mechanism is an advancing/withdrawing rotating mechanism that also serves as an advancing/withdrawing mechanism Due to this advancing/withdrawing rotating mechanism, the nozzle is rotated and displaced around the axis of the proximal portion thereof while moving so as to advance/withdraw along the axial direction of the proximal portion. Due thereto, a new variation of the locus of movement of the nozzle can be provided, and a new variation for avoiding interference between the nozzle and peripheral structures can be provided.

In a viewing device for a vehicle of a tenth aspect of the present disclosure, in the viewing device for a vehicle of the eighth aspect of the present disclosure, the advancing/withdrawing mechanism comprises a first mechanism that moves the nozzle so as to advance/withdraw along the axial direction of the proximal portion in a state in which a posture at a stored position is maintained, between the stored position at which the nozzle is stored and an intermediate reference position, which is a position at which the nozzle is advanced further than the stored position and is a position that is set in advance, and a second mechanism that also serves as the rotating mechanism configured to rotate and displace the nozzle around the axis of the proximal portion while moving the nozzle to advance/withdraw along the axial direction of the proximal portion, between the intermediate reference position and a jetting position that is a position at which the nozzle jets-out washing liquid.

In accordance with the viewing device for a vehicle of the tenth aspect of the present disclosure, a first mechanism and a second mechanism are provided as the advancing/withdrawing mechanism. The first mechanism moves the nozzle to advance/withdraw along the axial direction of the proximal portion in a state in which the posture of the nozzle at the stored position is maintained, between the stored position and the intermediate reference position. Further, the second mechanism also serves as the rotating mechanism, and rotates and displaces the nozzle around the axis of the proximal portion while moving the nozzle to advance/withdraw along the axial direction of the proximal portion, between the intermediate reference position and the jetting position. Due thereto, a new variation of the locus of movement of the nozzle can be provided, and a new variation for avoiding interference between the nozzle and peripheral structures can be provided.

In a viewing device for a vehicle of an eleventh aspect of the present disclosure, in the viewing device for a vehicle of the ninth aspect of the present disclosure, the advancing/withdrawing rotating mechanism comprises: a nozzle case that accommodates a portion of the nozzle and to which washing liquid is supplied; an urging member that urges the nozzle in a direction of the stored position; and a screw structure comprising screw portions provided at an outer peripheral portion of the proximal portion of the nozzle and an inner peripheral portion of the nozzle case respectively, with the screw portions screwed together.

In accordance with the viewing device for a vehicle of the eleventh aspect of the present disclosure, the nozzle is urged in the direction of the stored position by the urging member, in a state in which a portion of the nozzle is accommodated in the nozzle case, and washing liquid is supplied to the nozzle case. Here, screw portions are provided at the outer peripheral portion of the proximal portion of the nozzle and the inner peripheral portion of the nozzle case, respectively, and this is a screw structure that screws these together. As a result, when washing liquid is supplied to the nozzle case, and the nozzle is pushed against the urging force of the urging member, the nozzle is rotated and displaced around the axis of the proximal portion thereof while advancing along the axial direction of the proximal portion. Further, when the supply of the washing liquid to the nozzle case is stopped, the nozzle, which receives the urging force of the urging member, is rotated and displaced around the axis of the proximal portion thereof while withdrawing along the axial direction of the proximal portion, and returns to the stored position. Because the nozzle is displaced by the screw structure while the washing liquid is used as motive power, and further, the urging force of the urging member is utilized in this way, an increase in size of the structural portions that displace the nozzle can be suppressed, and the space for housing such structural portions can be kept small.

in a viewing device for a vehicle of a twelfth aspect of the present disclosure, in the viewing device for a vehicle of the tenth aspect of the present disclosure, the first mechanism comprises: a nozzle case that accommodates a portion of the nozzle and to which washing liquid is supplied; an urging member that urges the nozzle in a direction of the stored position; a shaft portion that stands erect from an outer peripheral surface of the proximal portion of the nozzle; and a first guiding portion that is formed at the nozzle case, rectilinearly along the axial direction of the proximal portion of the nozzle, and that guides the shaft portion, and the second mechanism comprises: the nozzle case; the urging member; the shaft portion; and a. second guiding portion that is formed at the nozzle case continuously with a distal end of the first guiding portion and so as to form a portion of a spiral, and that guides the shaft portion.

In accordance with the viewing device for a vehicle of the twelfth aspect of the present disclosure, the nozzle is urged in the direction of the stored position by the urging member, in a state in which a portion of the nozzle is accommodated in the nozzle case, and washing liquid is supplied to the nozzle case. The shaft portion, which stands erect from the outer peripheral surface of the nozzle, is guided along the axial direction of the proximal portion of the nozzle by the first guiding portion that is formed at the nozzle case. Further, the shaft portion is guided in the guiding direction, which is provided so as to form a portion of a spiral, by the second guiding portion that is formed continuously with the distal end of the first guiding portion at the nozzle case.

Due thereto, when washing liquid is supplied to the nozzle case, and the nozzle is pushed against the urging force of the urging member, the nozzle advances along the axial direction of the proximal portion of the nozzle while the posture thereof at the time of storage is maintained, and thereafter, while advancing along the axial direction of the proximal portion, is rotated and displaced around the axis of the proximal portion and is disposed at the jetting position. Further, when the supply of the washing liquid to the nozzle case is stopped, the nozzle, which receives the urging force of the urging member, is rotated and displaced around the axis of the proximal portion thereof while withdrawing along the axial direction of the proximal portion, and thereafter, withdraws along the axial direction of the proximal portion and is disposed at the stored position. The nozzle is displaced by using the shaft portion, the first guiding portion and the second guiding portion while the washing liquid is used as motive power, and further, the urging force of the urging member is utilized in this way. Therefore, an increase in size of the structural portions that displace the nozzle can be suppressed, and the space for housing such structural portions can be kept small.

In a viewing device for a vehicle of a thirteenth aspect of the present disclosure, in the viewing device for a vehicle of the seventh aspect of the present disclosure, the rotating mechanism comprises: a first enlarged diameter portion that is tubular, and whose diameter is enlarged via a first step portion from an axial direction intermediate portion of the proximal portion of the nozzle, and that extends at a proximal end side of the nozzle; a tubular body having an inserted tube portion that is inserted in the first enlarged diameter portion of the nozzle, and a second enlarged diameter portion that is tubular, and whose diameter is enlarged via a second step portion from an end portion at an opposite side from an insertion distal end side at the inserted tube portion, and that extends at an opposite side from an outer peripheral space side of the inserted tube portion; a nozzle case to which washing liquid is supplied and that has a case tube portion that is formed in a tubular shape, and houses the first step portion, the first enlarged diameter portion and the tubular body, and that is configured such that an inner peripheral surface thereof contacts an outer peripheral surface of the second enlarged diameter portion, that has a distal end side wall portion that extends toward a radial direction inner side of the case tube portion from a portion of a distal end side of the case tube portion, and that is disposed in a state of being contacted by the first step portion; a restricting portion that restricts movement of the first enlarged diameter portion toward an opposite side from the distal end side wall portion; an urging member that urges the tubular body in a direction of decreasing an inserted amount of the inserted tube portion in the first enlarged diameter portion, and that suppresses rotation of the tubular body around its own axis; a shaft portion that stands erect from an outer peripheral surface of a portion of a distal end portion side of the inserted tube portion; and a guiding portion that is formed at the first enlarged diameter portion of the nozzle so as to form a portion of a spiral, and that guides the shaft portion, and that is configured to, in a case of being pushed in an axial direction of the proximal portion by the shaft portion, rotate and displace the first enlarged diameter portion around the axis of the proximal portion.

In accordance with the viewing device for a vehicle of the thirteenth aspect of the present disclosure, the first enlarged diameter portion, which is tubular and whose diameter is enlarged via the first step portion from an axial direction intermediate portion of the proximal portion of the nozzle, extends at the proximal end side of the nozzle. Further, the first step portion of the nozzle is disposed in a state of contacting the distal end side wall portion of the nozzle case, and the restricting portion restricts movement of the first enlarged diameter portion toward the opposite side from the distal end side wall portion side. Accordingly, movement of the first step portion and the first enlarged diameter portion in a direction running along the axial direction of the proximal portion of the nozzle is impossible, and rotation and displacement around the axis of the proximal portion are possible.

Further, the inserted tube portion of the tubular body is inserted in the first enlarged diameter portion of the nozzle. At the tubular body, the second enlarged diameter portion, which is tubular and whose diameter is enlarged via the second step portion from the end portion at the opposite side from the inserted distal end side at the inserted tube portion, extends at the opposite side from the outer peripheral space side of the inserted tube portion. Because the outer peripheral surface of the second enlarged diameter portion of the tubular body contacts the inner peripheral surface of the case tube portion of the nozzle case, in a case in which the tubular body advances along the axial direction thereof due to the liquid pressure of the washing liquid, the tubular body can move stably. Further, the tubular body is urged by the urging member in the direction of decreasing the inserted amount of the inserted tube portion in the first enlarged diameter portion, and rotation around the axis of the tubular body is suppressed by the urging member.

Moreover, the shaft portion stands erect from the outer peripheral surface of the portion of the distal end portion side of the inserted tube portion. The guiding portion is configured to rotate and displace the first enlarged diameter portion around the axis of the proximal portion, in a case in which the guiding portion, which is formed at the first enlarged diameter portion of the nozzle so as to form a portion of a spiral, is pushed by the shaft portion. Due thereto, when washing liquid is supplied to the nozzle case, and the tubular body advances against the urging force of the urging member, the shaft portion of the tubular body pushes the guiding portion of the nozzle, and the nozzle is rotated and displaced around the axis of the proximal portion thereof without the position in the axial direction of the proximal portion changing. In this way, the space at the periphery of the stored position of the nozzle can be made to be small due to the nozzle not stroking in the axial direction of the proximal portion thereof. Further, when supply of washing liquid to the nozzle case is stopped, the tubular body that receives the urging force of the urging member withdraws. Therefore, the shaft portion of the tubular body pushes the guiding portion of the nozzle, and the nozzle is rotated and displaced around the axis of the proximal portion thereof without the position in the axial direction of the proximal portion changing, and the nozzle returns to the stored position.

### Advantageous Effects of Invention

As described above, in accordance with the viewing device for a vehicle of the present disclosure, there is the excellent effect that a cover being imaged by a viewing assistance portion at the time of cleaning the main surface side of the viewing assistance portion can be prevented or suppressed.

Further, in accordance with the viewing device for a vehicle of the present disclosure, there is the excellent effect that, even in a case in which an intermediate portion of a nozzle is bent, the space needed for storing and moving the nozzle can be kept small.

### BRIEF DESCRIPTION OF DRAWINGS

FIG. 1A is a side view showing a portion of a vehicle, in which a viewing device for a vehicle relating to a first embodiment is installed, in a state of being seen from a vehicle lateral side.

FIG. 1B is a plan view showing the viewing device for a vehicle of FIG. 1A and a peripheral portion thereof, in a state of being seen from a vehicle upper side.

FIG. 2A is a cross-sectional view showing a non-operating state of a washing device of the viewing device for a vehicle relating to the first embodiment, in an enlarged manner in a cross-section along line 2A-2A of FIG. 1B;

FIG. 2B is a cross-sectional view showing an operating state of the washing device of FIG. 2A;

FIG. 3A is an enlarged sectional view in which the state cut along line 3A-3A of FIG. 2A is enlarged.

FIG. 3B is an enlarged sectional view in which the state cut along line 3B-3B of FIG. 2A is enlarged.

FIG. 4A is a cross-sectional view showing a non-operating state of a washing device of a viewing device for a vehicle relating to a second embodiment, in a cross-section corresponding to FIG. 2A.

FIG. 4B is a cross-sectional view showing an operating state of the washing device of FIG. 4A.

FIG. 5 is an enlarged sectional view in which the state cut along line 5-5 of FIG. 4A is enlarged.

FIG. 6A is a cross-sectional view showing a non-operating state of a washing device of a viewing device for a vehicle relating to a third embodiment, in a cross-section corresponding to FIG. 2A.

FIG. 6B is a cross-sectional view showing an operating state of the washing device of FIG. 6A.

FIG. 7A is a side view showing a portion of a vehicle, in which a viewing device for a vehicle relating to fourth embodiment is installed, in a state of being seen from a vehicle lateral side.

FIG. 7B is a plan view showing the viewing device for a vehicle of FIG. 7A and a peripheral portion thereof, in a state of being seen from a vehicle upper side.

FIG. 8A is a cross-sectional view in which a non-operating state of a washing device of the viewing device for a vehicle relating to the fourth embodiment is shown in an enlarged manner in a cross-section along line 8A-8A of FIG. 7B.

FIG. 8B is a cross-sectional view showing an operating state of the washing device of FIG. 8A.

FIG. 9A is a cross-sectional view showing a non-operating state of a washing device of a viewing device for a vehicle relating to a fifth embodiment, in a cross-section corresponding to FIG. 8A.

FIG. 9B is a cross-sectional view showing an operating state of the washing device of FIG. 9A.

FIG. 10 is a cross-sectional view showing the state cut along line D-D of FIG. 9A in an enlarged manner.

FIG. 11A is a cross-sectional view showing a non-operating state of a washing device of a viewing device for a vehicle relating to a sixth embodiment, in a cross-section corresponding to FIG. 8A.

FIG. 11B is a cross-sectional view showing an operating state of the washing device of FIG. 11A.

FIG. 12 is an exploded perspective view showing, in an exploded manner, a nozzle unit of the washing device of FIG. 11A, wherein illustration of a tension spring is omitted.

FIG. 13A is a drawing showing, in an enlarged manner, the state seen from the direction of arrow 13A of FIG. 11A.

FIG. 13B is a cross-sectional view showing the state cut along line 13B-13B of FIG. 11A in an enlarged manner.

### DESCRIPTION OF EMBODIMENTS

### First Embodiment

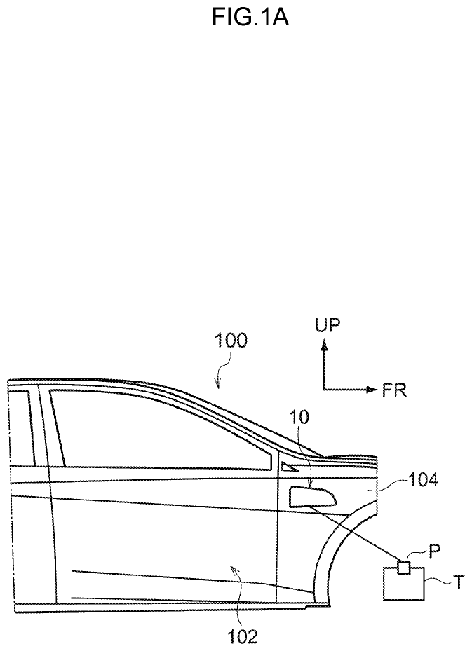

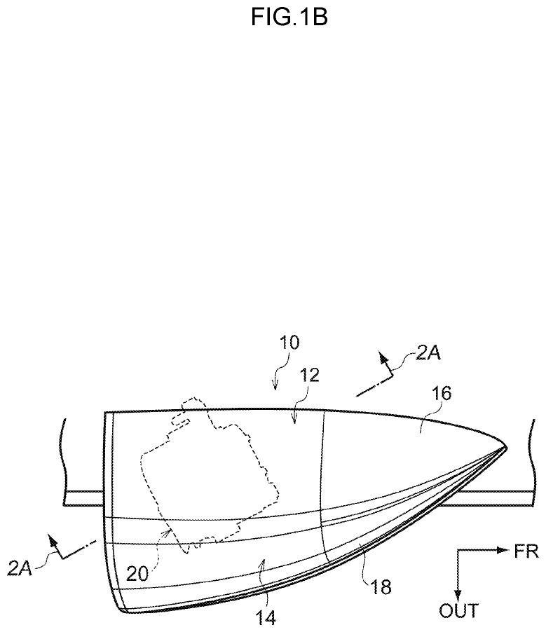

A viewing device for a vehicle relating to a first embodiment of the present disclosure is described by using FIG. 1A through FIG. 3B. Note that arrow FR that is shown appropriately in these drawings indicates the vehicle front side, arrow UP indicates the vehicle upper side, and arrow OUT indicates a vehicle transverse direction outer side.

A side view of a state in which a portion of a vehicle 100, in which a viewing device 10 for a vehicle relating to the present embodiment is installed, is seen from a vehicle lateral side is shown in FIG. 1A. A plan view of a state in which the viewing device 10 for a vehicle and a peripheral portion thereof are seen from the vehicle upper side is shown in FIG. 1B.

As shown in FIG. 1A, the viewing device 10 for a vehicle is, as an example, provided at the upper portion and vehicle rear side end portion of a fender panel 104 of a vehicle side portion 102. As shown in FIG. 1B, the viewing device 10 for a vehicle has a visor 12. The visor 12 is made of resin, and the outer peripheral surface of the visor 12 structures the design surface of the viewing device 10 for a vehicle. The visor 12 is supported at the vehicle body side in a fixed state via a supporting mechanism (not shown) that is provided at the interior of the visor 12. The vehicle rear side portion of the visor 12 is structured by a visor rim 14 that serves as a panel member. Further, the vehicle front side and upper side portion of the visor 12 is structured by an upper visor cover 16, and the vehicle front side and lower side portion of the visor 12 is structured by a lower visor cover 18. The visor 12 that is structured in this way houses a camera unit 20 in the interior thereof.

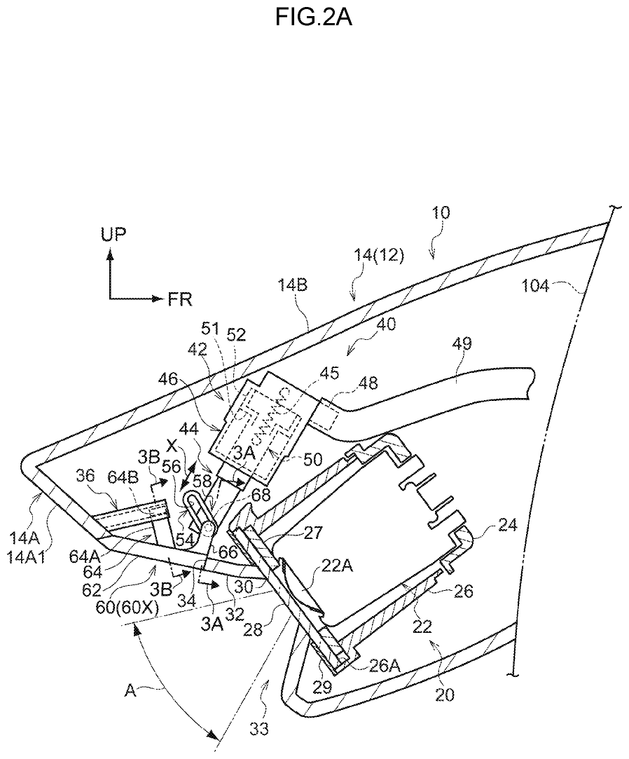

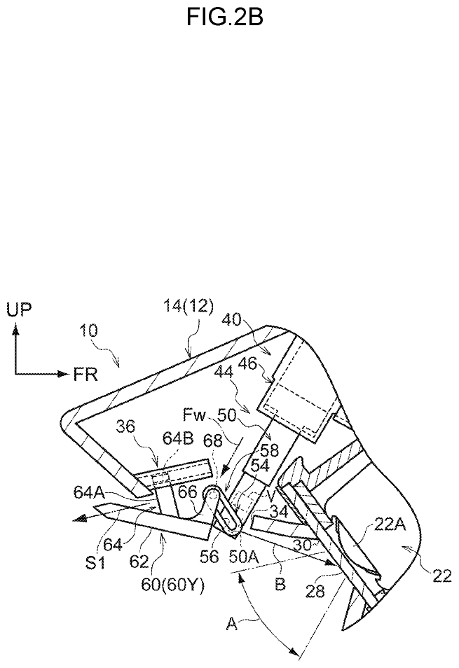

A cross-sectional view of a state in which the cross-section along line 2A-2A of FIG. 1B is enlarged is shown in FIG. 2A. This FIG. 2A shows a non-operating state of a washing device 40, which is described later, of the viewing device 10 for a vehicle, and FIG. 2B shows an operating state of the washing device 40.

As shown in FIG. 2A, the camera unit 20 is structured to include a camera 22 that serves as a viewing assistance portion that assists viewing by an occupant of the vehicle. The camera 22 has, at the main surface side thereof, a lens 22A, and this lens 22A faces the vehicle rear side. The camera 22 is electrically connected to a control device (not shown) of the vehicle, and can capture images of the vehicle rear side by control of the control device. A monitor (not shown) is electrically connected to the control device, and the monitor can display the images captured by the camera 22, by control of the control device. The monitor is set within the vehicle cabin, and, due to an occupant of the vehicle (in particular, the driver) viewing the image displayed on the monitor, viewing of the vehicle rear side by the vehicle occupant is assisted.

The portion, which is at the opposite side from the lens 22A side, of the camera 22 is mounted to a first bracket 24 that is box-shaped. The first bracket 24 is fixed to the aforementioned supporting mechanism (not illustrated). A second bracket 26 that is tubular is provided at the vehicle rear side portion of the first bracket 24, and the camera 22 is disposed at the inner side of the second bracket 26. The diameter of the vehicle rear side end portion of the inner surface of the second bracket 26 is enlarged via a step. A cover glass 28 that is plate-shaped is fit-together with an opening portion 26. A of the vehicle rear side end portion of the second bracket 26. The cover glass 28 can transmit light therethrough, and closes-off the opening portion 26A of the vehicle rear side end portion of the second bracket 26. One surface of double-sided tape 27 is affixed to the outer peripheral portion of the vehicle front side of the cover glass 28 over the entire periphery thereof, and the outer peripheral side of another surface of the double-sided tape 27 is affixed to the step surface of the second bracket 26 over the entire periphery thereof. Further, a heater 29 that is sheet-shaped is adhered to the outer peripheral portion of the vehicle rear side of the cover glass 28 over the entire periphery thereof.

The visor rim 14 has a rear wall portion 14A that structures the vehicle rear side portion of the visor rim 14 and faces the vehicle rear side, and has a peripheral wall portion 14B that extends toward the vehicle front side from the rear wall portion 14A. The peripheral wall portion 14B is a substantial U-shape whose vehicle transverse direction inner side is open, as seen from the vehicle rear side (not shown). Further, a window 30 that is circular is formed so as to penetrate the rear wall portion 14A. An annular wall portion 32, which is tilted such that the diameter thereof increases from the peripheral end of the window 30 toward the vehicle rear side, is formed at the outer peripheral side of the window 30. The lens 22A of the camera 22 is disposed so as to face the exterior from the window 30, and the camera 22 captures images of the vehicle rear side via the window 30.

The annular wall portion 32 structures the peripheral portion of the main surface side of the camera 22. and is disposed outside of the range of image angle A of the camera 22. Moreover, a portion of the above-described cover glass 28 is exposed from the window 30, and a recessed portion 33, which is recessed toward the vehicle front side with respect to a general portion 14A1 of the rear wall portion 14A, is formed by the annular wall portion 32 and a portion of the cover glass 28. An opening portion 34 for projection/retraction of a nozzle 44 that is described later is formed so as to penetrate the annular wall portion 32. The opening portion 34 is formed further toward the vehicle upper side than the window 30.

A nozzle unit 42 is housed in the interior of the visor 12 at the vehicle upper side with respect to the camera unit 20. Note that, in the drawings, the nozzle unit 42 is shown in a side view and not in cross-section. The nozzle unit 42 is made of resin, and structures a portion of the washing device 40, and is provided in order to jet washing liquid toward the cover glass 28 that is the object of washing in the present embodiment (in other words, toward the main surface side of the camera 22). A hose 49 is connected to the nozzle unit 42, and a pump P that is shown schematically in FIG. 1A is connected to the hose 49. The pump P feeds washing liquid that is stored in a tank T (illustrated schematically). Further, due to the pump P operating, washing liquid is supplied from the hose 49 shown in FIG. 2A to the nozzle unit 42. As an example, the nozzle unit 42 is structured to include the nozzle 44 and a nozzle case 46.

The nozzle case 46 is fixed to the interior of the visor 12. The nozzle case 46 is a case that is shaped as a tube having a bottom. Washing liquid is supplied to the interior of the nozzle case 46 due to the nozzle case 46 being connected to the hose 49 via a connecting tube portion 48. A portion of the nozzle 44 is accommodated in the nozzle case 46.

As shown in FIG. 2B, a portion of the distal end portion side of the nozzle 44 is made able to project/retract from the opening portion 34 (details described later). The nozzle 44 has a nozzle main body portion 50 that is shaped as a tube and extends rectilinearly. A jetting port 50A that jets-out washing liquid is formed in a portion of the distal end portion side of the nozzle main body portion 50 at the nozzle 44. Further, a check valve V, which opens in a case in which the pressure at the interior of the nozzle main body portion 50 exceeds a predetermined value, is provided at a portion of the distal end portion side of the nozzle main body portion 50. The nozzle 44 is structured so as to jet washing liquid from the jetting port 50A toward the exposed portion side of the cover glass 28 (in other words, the main surface side of the camera 22), due to the check valve V opening in a state in which the nozzle 44 projects-out from the opening portion 34. In the drawings, the direction in which the washing liquid is jetted is shown by arrow B.

As shown in FIG. 2A, the nozzle 44 has an enlarged diameter portion 52 Whose diameter is enlarged via a step portion 51 from the proximal end portion of the nozzle main body portion 50, and that extends-out toward the proximal end side of the nozzle 44. The enlarged diameter portion 52 is formed in the shape of a short cylindrical tube. The outer peripheral surface of the enlarged diameter portion 52 is disposed along the inner surface of the nozzle case 46.

A tension spring 45 is housed at the interior of the nozzle 44. One end of this tension spring 45 is connected to the proximal end side of the nozzle case 46, and another end is connected to the nozzle main body portion 50. In the non-operating state of the washing device 40, the nozzle 44 is pulled toward the proximal end side of the nozzle case 46 by the tension of the tension spring 45.

Further, a cover 60 is provided at the opening portion 34 so as to open/close. Note that, in the drawings, the cover 60 is shown in a side view and not in cross-section. The cover 60 is made of resin. The surface of a cover main body portion 62 that is the main body portion of the cover 60 forms a design surface that is continuous with the surface of the annular wall portion 32.

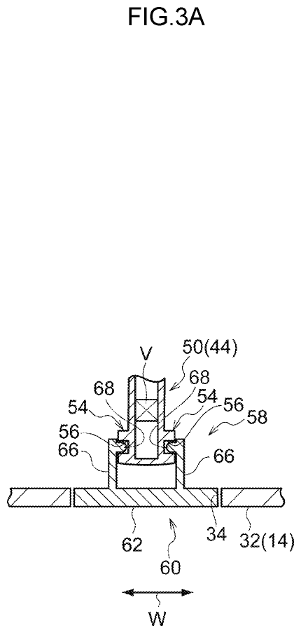

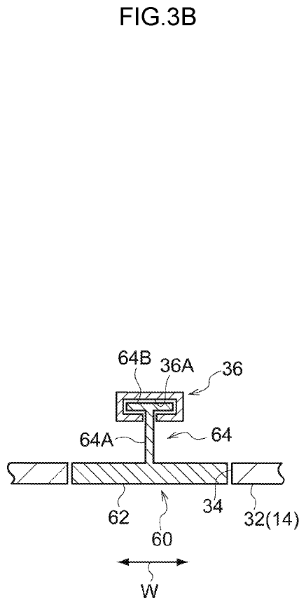

An enlarged cross-sectional view, in which the state cut along line 3B-3B of FIG. 2A is enlarged, is shown in FIG. 3B. As shown in FIG. 3B, a projecting portion 64 that is substantially T-shaped is provided at the reverse surface side of the cover main body portion 62. The projecting portion 64 has a vertical wall portion 64A that is formed so as to project-out from an intermediate portion in width direction W of the reverse surface side of the cover main body portion 62, and has a lateral wall portion 6413 that extends in the width direction W at the projecting direction distal end portion of the vertical wall portion 64A. As shown in FIG. 2A, the vertical wall portion 64A stands erect from a length direction intermediate portion of the cover main body portion 62 as seen in a side view of the cover 60, and is slightly tilted toward the side of moving away from the nozzle 44 while heading from the reverse surface of the cover main body portion 62 in the standing erect direction.

The lateral wall portion 64B of the projecting portion 64 that is shown in FIG. 3B is disposed so as to slide along a guide rail 36. The guide rail 36 is structured to include a guide groove portion 36A whose cross-sectional shape orthogonal to the length direction is substantially T-shaped. As shown in FIG. 2A, the guide rail 36 stands erect from the reverse surface side of a region that is a peripheral portion of the opening portion 34 and is at the side far from the main surface of the camera 22, and, as seen in the direction of FIG. 2A, extends in a direction orthogonal to the extending direction of the vertical wall portion 64A of the projecting portion 64. Due to the above, the cover 60 is provided so as to slide between a closing position 60X (see FIG. 2A) of closing the opening portion 34, and an opening position 60Y (see FIG. 2B) that is set further toward the side that is far from the main surface of the camera 22 than the closing position 60X. As shown in FIG. 2B, the opening position 60Y is set outside of the range of image angle A of the camera 22. Note that the opening position 60Y can be set appropriately at a position at which imaging by the camera 22 can be prevented or suppressed.

An enlarged sectional view, in which the state cut along line 3A-3A of FIG. 2A is enlarged, is shown in FIG. 3A. Note that, in FIG. 3A, the check valve V is illustrated in a simplified manner. As shown. in FIG. 3A, a pair of projecting wall portions 66 stand erect at the reverse surface side of the cover main body portion 62. As shown in FIG. 2A, the projecting wall portions 66 are formed at further toward the side near to the main surface of the camera 22 than the projecting portion 64. As shown in FIG. 3A, shaft portions 68, which project-out from the facing portions toward the width direction inner sides (sides of approaching one another), are formed at the projecting direction distal end sides of the pair of projecting wall portions 66.

The shaft portions 68 are formed in the shapes of short solid cylinders, and are slidably housed in guiding portions 56 that are provided at the nozzle 44. As shown in FIG. 2A, elongated portions 54 that are elongated are formed integrally with side portions of the nozzle main body portion 50. and the guiding portions 56 are formed in the elongated portions 54. The elongated portions 54 are formed at the side portions at the both sides of the nozzle main body portion 50 respectively, and the guiding portions 56 are long holes. The elongated portions 54 and the guiding portions 56 extend from the distal end portion of the nozzle main body portion 50, and are inclined toward the proximal end side of the nozzle main body portion 50 while heading toward the side away from the main surface of the camera 22.

The guiding portions 56 guide the shaft portions 68 such that the cover 60 is slid and opened/closed in accordance with movement of the nozzle 44 in projecting/retracting direction X. Namely, the viewing device TO for a vehicle of the present embodiment has an interlocking mechanism 58 that has the guiding portions 56 and the shaft portions 68, and this interlocking mechanism 58 connects the nozzle 44 and the cover 60. Further, by using the force of the nozzle 60 being displaced, the interlocking mechanism 58 displaces the cover 60 in a direction that is different than the direction in which the nozzle 60 is displaced so as to openiclose the cover 60. Here, the interlocking mechanism 58 has the function of sliding the cover 60 from the closing position 60X (see FIG. 2A) to the opening position 60Y (see FIG. 213) by using the force of the nozzle 44 advancing to the position projecting out from the opening portion 34 (force in the arrow Fw direction of FIG. 2B), and combines function of sliding the cover 60 from the opening position 60Y (see FIG. 2B) to the closing position 60X (see FIG. 2A) by using the force of the nozzle 44, which is in the state of projecting-out from the opening portion 34, withdrawing.

(Operation/Effects)

Operation and effects of the above-described embodiment are described next.

in the present embodiment, viewing by an occupant of the vehicle shown in FIG. 2A is assisted by the camera 22. Further, in a case in which the exposed portion of the cover glass 28 of the main surface side of the camera 22 is dirty, the pump P (see FIG. 1A) operates automatically or manually, and washing liquid is supplied to the interior of the nozzle case 46. When the washing liquid flows ftom the nozzle case 46 interior into the nozzle 44, the nozzle 44 advances against the tension of the tension spring 45. Then, as shown in FIG. 2B, when the nozzle 44 projects-out from the opening portion 34, and the pressure of the washing liquid at the interior of the nozzle 44 exceeds a predetermined value, the check valve V opens, and washing liquid is jetted out from the jetting port 50A toward the exposed portion side of the cover glass 28 (in other words, the main surface side of the camera 22).

Here, the cover 60 can slide between the closing position 60X of closing the opening portion 34 shown in FIG. 2A, and the opening position 60Y (see FIG. 2B) that is set further toward the side that is far from the main surface of the camera 22 than the closing position 60X. Further, by using the force of the nozzle 60 being displaced, the interlocking mechanism 58 displaces the cover 60 in a direction that is different than the direction in which the nozzle 60 is displaced so as to open/close the cover 60. Here, the interlocking mechanism 58 slides the cover 60 from the closing position 60X to the opening position 60Y shown in FIG. 2B (refer to arrow S1) by using the force of the nozzle 44 advancing to the position projecting out from the opening portion 34 (force in the arrow Fw direction of FIG. 2B). In this way, in a case of opening the opening portion 34, the cover 60 is slid to the side far from the main surface of the camera 22, and therefore, the cover 60 being imaged by the camera 22 is prevented or suppressed.

Further, in the present embodiment, the interlocking mechanism 58 connects the nozzle 44 and the cover 60, and slides the cover 60 from the opening position 60Y to the closing position 60X shown. in FIG. 2A by using the force of the nozzle 44, which is in the state of projecting-out from the opening portion 34, withdrawing. Namely, the interlocking mechanism 58 can open/close the cover 60 by using the motive power that projects/retracts the nozzle 44.

To describe this more concretely, in the present embodiment, the guiding portions 56 that are provided at the nozzle 44 guide the shaft portions 68 provided at the cover 60, such that the cover 60 slides and is opened/closed in accordance with movement of the nozzle 44 in the projecting/retracting direction X. Accordingly, in the present embodiment, complexity of the structure also can be suppressed.

As described above, in accordance with the viewing device 10 for a vehicle of the present embodiment, the cover 60 being imaged. by the camera 22 at the time of washing the main surface side of the camera 22 can be prevented or suppressed.

### Second Embodiment

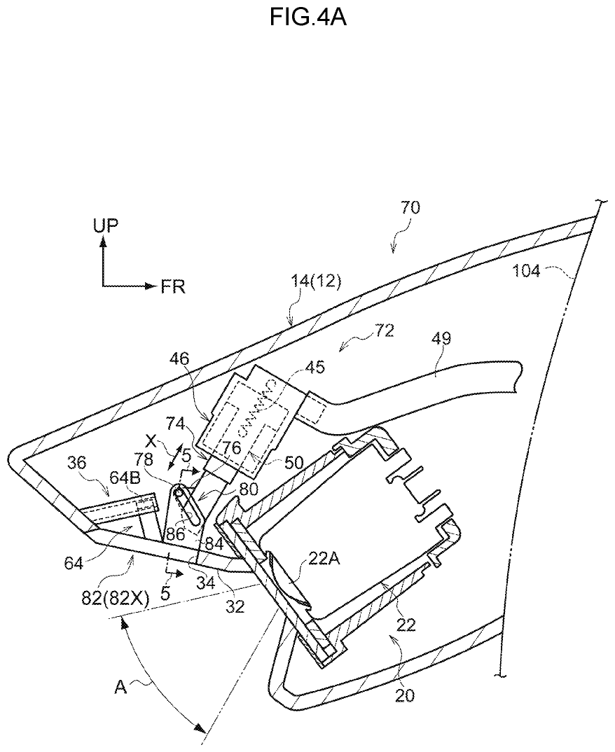

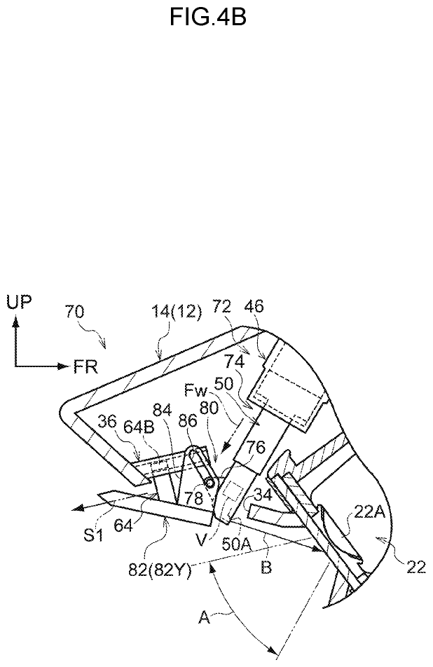

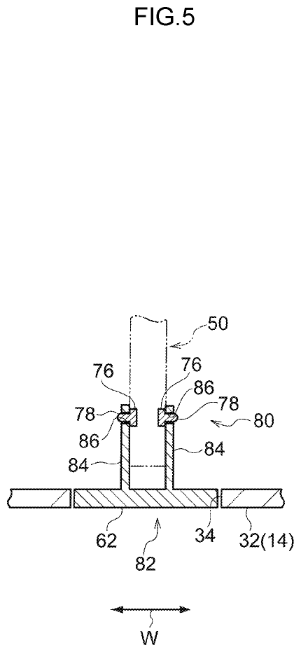

A viewing device for a vehicle relating to a second embodiment of the present disclosure is described by using FIG. 4A through FIG. 5. The non-operating state of a washing device 72 of a viewing device 70 for a vehicle relating to the present embodiment is shown. in FIG. 4A in a cross-sectional view of a state that is cut at a similar cutting position as FIG. 2A. The operating state of the washing device 72 is shown in a cross-sectional view in FIG. 4B. Further, an enlarged sectional view, in which the state cut along line 5-5 of FIG. 4A is enlarged, is shown in FIG. 5.

As shown in these drawings, the viewing device 70 for a vehicle relating to the present embodiment differs from the viewing device 10 for a vehicle relating to the first embodiment (see FIG. 2A) with regard to the point of having an interlocking mechanism 80 instead of the interlocking mechanism 58 of the first embodiment (see FIG. 2A). The other structures are structures that are substantially similar to those of the first embodiment. Accordingly, structural portions that are substantially similar to those of the first embodiment are denoted by the same reference numerals, and description thereof is omitted.

As shown in FIG. 4A, a nozzle 74 in the present embodiment has protruding portions 76 at which shaft portions 78 are formed, instead of the elongated portions 54 at which the guiding portions 56 are formed (refer to FIG. 2A and the like for both) of the first embodiment. The other points are structures that are substantially similar to those of the nozzle 44 (refer to FIG. 2A and the like) of the first embodiment, and are made of resin. Note that the portion, which is at the distal end portion side of the nozzle main body portion 50 of the nozzle 74 in the present embodiment and is at the opposite side from the camera 22 side, is chamfered in order to avoid interference with a cover 82. Although this point differs from the nozzle main body portion 50 of the first embodiment, the other points are similar to those of the nozzle main body portion 50 of the first embodiment, and therefore are denoted by the same reference numerals for convenience.

The pair of protruding portions 76 protrude-out from a portion of the distal end portion side of the nozzle main body portion 50, at the opposite side from the camera 22 side. As shown in FIG. 5, the shaft portions 78, which project-out toward the width direction outer sides (sides of moving away from one another) respectively, are formed at the projecting direction distal end sides of the pair of protruding portions 76.

The shaft portions 78 are formed in the shapes of short solid cylinders, and are slidably housed in guiding portions 86 that are provided in the cover 82. The guiding portions 86 are long holes that are formed so as to penetrate projecting wall portions 84 that are formed integrally with the reverse surface side of the cover main body portion 62 at the cover 82. The projecting wall portions 84 are formed as a pair at an intermediate portion in the width direction W of the reverse surface side of the cover main body portion 62. As shown in FIG. 4A, the guiding portions 86 extend from the distal end portions of the projecting wall portions 84, and are inclined toward sides of approaching the main surface of the camera 22 while heading toward the proximal end sides of the projecting wall portions 84.

Further, as shown in FIG. 4A, the cover 82 of the present embodiment has the projecting wall portions 84 in which the guiding portions 86 are formed, instead of the projecting wall portions 66 at which the shaft portions 68 of the first embodiment are formed (refer to FIG. 2A and the like for both), and the other points are structures that are substantially similar to those of the cover 60 of the first embodiment (refer to FIG. 2A and the like), and are made of resin.

The guiding portions 86 are configured to guide the shaft portions 78 and so as to slide and open/close the cover 82 by receiving load from the shaft portions 78 in accordance with movement of the nozzle 74 in the projecting/retracting direction X (see FIG. 4A). Namely, the viewing device 70 for a vehicle of the present embodiment has the interlocking mechanism 80 that has the shaft portions 78 and the guiding portions 86, and this interlocking mechanism 80 connects the nozzle 74 and the cover 82. Further, by using the force of the nozzle 74 being displaced, the interlocking mechanism 80 displaces the cover 82 in a direction that is different than the direction in which the nozzle 74 is displaced so as to open/close the cover 82. Here, the interlocking mechanism 80 has the function of sliding the cover 82 from a closing position 82X (see FIG. 4A) to an opening position 82Y (see FIG. 4B) by using the force of the nozzle 74 advancing to the position projecting out from the opening portion 34 (force in the arrow Fw direction of FIG. 413), and combines the function of sliding the cover 82 from the opening position 82Y (see FIG. 4B) to the closing position 82X (see FIG. 4A) by using the force of the nozzle 74, which is in the state of projecting-out from the opening portion 34 shown in FIG. 4B, withdrawing.

In accordance with the structure of the present embodiment as well, operation and effects that are similar to those of the above-described first embodiment are obtained.

### Third Embodiment

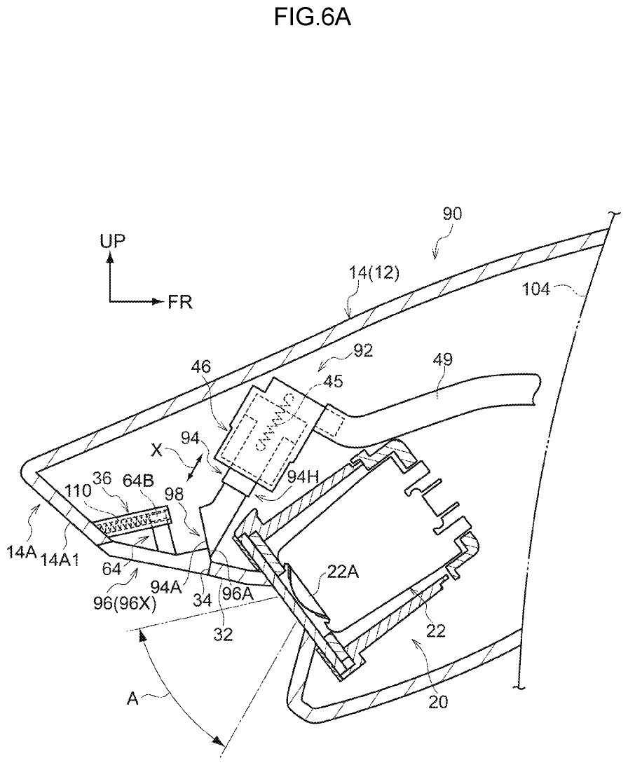

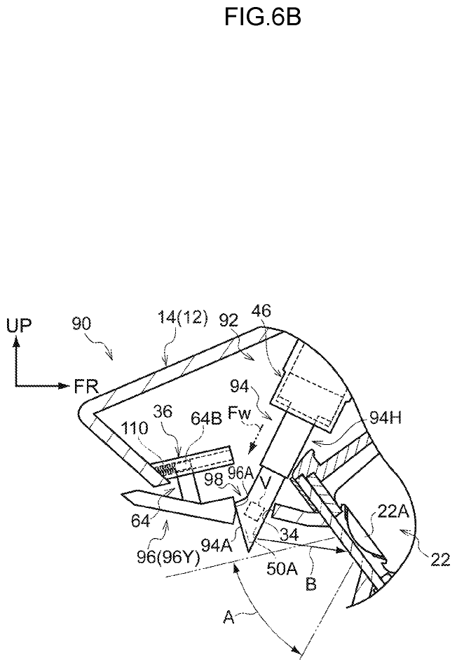

A viewing device for a vehicle relating. to a third embodiment of the present disclosure is described by using FIG. 6A and FIG. 6B. The non-operating state of a washing device 92 of a viewing device 90 for a vehicle relating to the present embodiment is shown in FIG. 6A in a cross-sectional view of a state that is cut at a similar cutting position as FIG. 2A. The operating state of the washing device 92 is shown in a cross-sectional view in FIG. 6B.

As shown in these drawings, the viewing device 90 for a vehicle relating to the present embodiment differs from the viewing device 10 for a vehicle relating to the first embodiment (see FIG. 2A) with regard to the points of having an interlocking mechanism 98 and having an urging member 110 within the guide rail 36, instead of the interlocking mechanism 58 of the first embodiment (see FIG. 2A). The other structures are structures that are substantially similar to those of the first embodiment. Accordingly, structural portions that are substantially similar to those of the first embodiment are denoted by the same reference numerals, and description thereof is omitted.

A nozzle 94 in the present embodiment has a pushing inclined portion 94A that structures a portion of the interlocking mechanism 98, instead of the elongated portions 54 at Which the guiding portions 56 are formed (refer to FIG. 2A and the like for both) of the first embodiment. The other points are structures that are substantially similar to those of the nozzle 44 (refer to FIG. 2A) of the first embodiment, and are made of resin. The pushing inclined portion 94A is a portion that is inclined toward the opposite side from the camera 22 side, while heading from the distal end toward the proximal end side of a nozzle main body portion 94A. The proximal end portion of the pushing inclined portion 94A is positioned at a portion, which protrudes-out toward the opposite side from the camera 22 side, at the nozzle main body portion 94H. Note that the nozzle main body portion 94H is structured similarly to the nozzle main body portion 50 of the first embodiment, except for the above-described points.

Further, a cover 96 in the present embodiment has a pushed inclined portion 96A that structures a portion of the interlocking mechanism 98, instead of the projecting wall portions 66 at which the shaft portions 68 are formed (refer to FIG. 2A and the like for both) of the first embodiment. The other points are structures that are substantially similar to those of the cover 60 (see FIG. 2A) of the first embodiment, and are made of resin.

The pushed inclined portion 96A is formed at a portion of the end surface at the camera 22 side of the cover 96, and is disposed further toward the nozzle 94 side than the reverse surface of the annular wall portion 32 in the state in which the cover 96 is at a closing position 96X shown in FIG. 6A, and is inclined so as to planarly contact the distal end side of the pushing inclined portion 94A of the nozzle 94. Further, in a case in which the nozzle 94 advances, the pushed inclined portion 96A of the cover 96 is pushed by the pushing inclined portion 94A of the nozzle 94, and the cover 96 slides from the closing position 96X to an opening position 96Y shown in FIG. 6B. Namely, by using the force of the nozzle 94 being displaced, the interlocking mechanism 98 of the present embodiment displaces the cover 96 in a direction that is different than the direction in which the nozzle 94 is displaced so as to open/close the cover 96. Here, the interlocking mechanism 98 has the pushing inclined portion 94A and the pushed inclined portion 96A, and is structured so as to slide the cover 96 from the closing position 96X (see FIG. 6A) to the opening position 96Y by using the force of the nozzle 94 advancing to the position projecting out from the opening portion 34 (force in the arrow Fw direction of FIG. 6B).

On the other hand, the urging member 110 that is provided within the guide rail 36 is a compression coil spring, and is disposed between the general portion 14A1 of the rear wall portion 14A of the visor rim 14 and the lateral wall portion 64B of the projecting portion 64 provided at the cover 96. The urging member 110 is structured so as to urge the cover 96 in the direction of the closing position 96X shown in FIG. 6A.

In accordance with the present embodiment, in a case in which the nozzle 94 that is shown in FIG. 6A advances as shown in FIG. 6B, due to the pushed inclined portion 96A of the cover 96 being pushed by the pushing inclined portion 94A of the nozzle 94, the cover 96 slides from the closing position 96X shown in FIG. 6A to the opening position 96Y shown in FIG. 6B. On the other hand, because the cover 96 is urged in the direction of the closing position 96X (see FIG. 6A) by the urging member 110, when the nozzle 94, which is in the state of projecting-out from the opening portion 34 shown in FIG. 6B, withdrawing as shown in FIG. 6A, the cover 96 is closed by the urging force of the urging member 110.

As described above, in accordance with the present embodiment as well, the cover 96 being imaged by the camera 22 at the time of washing the main surface side of the camera 22 can be prevented or suppressed.

### Modified Example of Embodiment

Note that, as a modified example of the above-described third embodiment, there may be a structure in which a tension coil spring is used as the urging member for urging the cover (96) in the direction of the closing position.

Further, although the viewing assistance portion in the above-described first through third embodiments is the camera 22, the viewing assistance portion may be another viewing assistance portion such as a mirror or the like for example.

### Fourth Embodiment

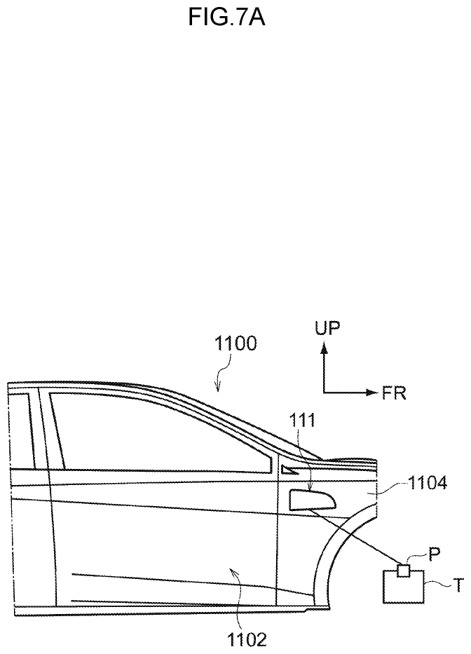

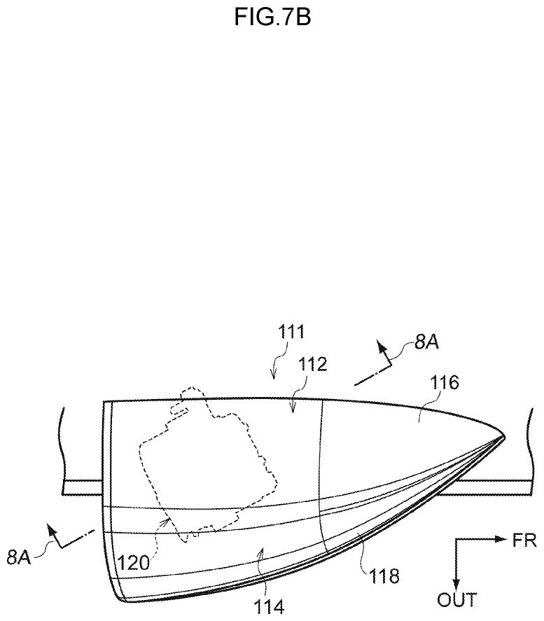

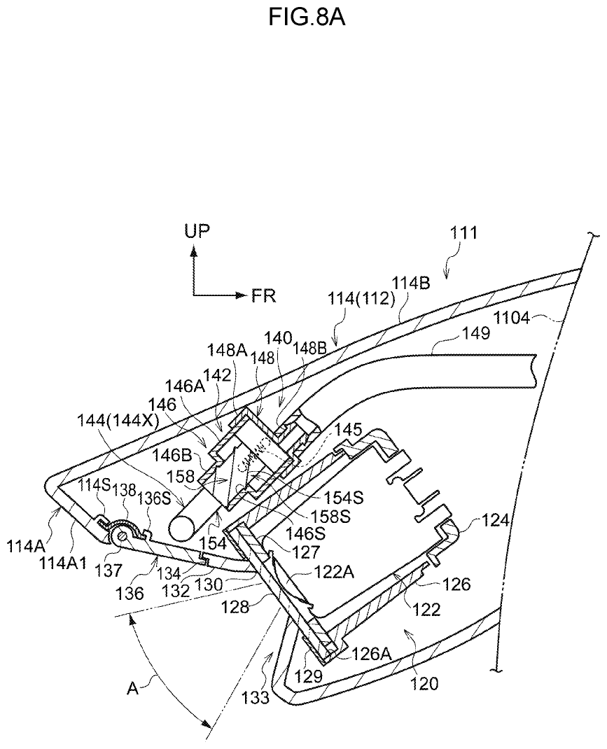

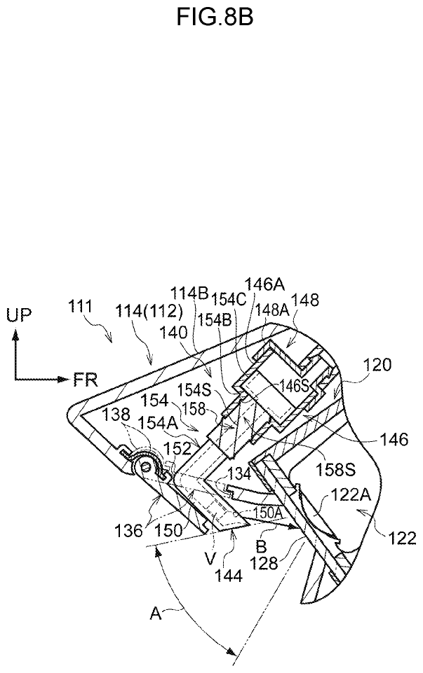

A viewing device for a vehicle relating to a fourth embodiment of the present invention is described next by using FIG. 7A through FIG. 8B. Note that arrow FR that is shown appropriately in these drawings indicates the vehicle front side, arrow UP indicates the vehicle upper side, and arrow OUT indicates a vehicle transverse direction outer side.

A side view of a state in which a portion of a vehicle 1100, in which a viewing device 111 for a vehicle relating to the present embodiment is installed, is seen from a vehicle lateral side is shown in FIG. 7A. A plan view of a state in which the viewing device 111 for a vehicle and a peripheral portion thereof are seen from the vehicle upper side is shown in FIG. 7B.

As shown in FIG. 7A, the viewing device 111 for a vehicle is, as an example, provided at the upper portion and vehicle rear side end portion of a fender panel 1104 of a vehicle side portion 1102. As shown in FIG. 7B, the viewing device 111 for a vehicle has a visor 112 that serves as a housing body. The visor 112 is made of resin, and the outer peripheral surface of the visor 112 structures the design surface of the viewing device 111 for a vehicle. The visor 112 is supported at the vehicle body side in a fixed state via a supporting mechanism (not shown) that is provided at the interior of the visor 112. The vehicle rear side portion of the visor 112 is structured by a visor rim 114 that serves as a panel member. Further, the vehicle front side and upper side portion of the visor 112 is structured by an upper visor cover 116, and the vehicle front side and lower side portion of the visor 112 is structured by a lower visor cover 118. The visor 112 that is structured in this way houses a camera unit 120 in the interior thereof.

A cross-sectional view of a state in which the cross-section along line 8A-8A of FIG. 7B is enlarged is shown in FIG. 8A. This FIG. 8A shows a non-operating state of a washing device 140, which is described later, of the viewing device 111 for a vehicle, and FIG. 8B shows an operating state of the washing device 140.

As shown in FIG. 8A, the camera unit 120 is structured to include a camera 122 that serves as a viewing assistance portion that assists viewing by an occupant of the vehicle. The camera 122 has, at the main surface side thereof, a lens 122A, and this lens 122A faces the vehicle rear side. The camera 122 is electrically connected to a control device (not shown) of the vehicle, and can capture images of the vehicle rear side by control of the control device. A monitor (not shown) is electrically connected to the control device, and the monitor can display the images captured by the camera 122, by control of the control device. The monitor is set within the vehicle cabin, and, due to an occupant of the vehicle (in particular, the driver) viewing the image displayed on the monitor, viewing of the vehicle rear side by the vehicle occupant is assisted.

The portion, which is at the opposite side from the lens 122A side, of the camera 122 is mounted to a first bracket 124 that is box-shaped. The first bracket 124 is fixed to the aforementioned supporting mechanism (not illustrated). A second bracket 126 that is tubular is provided at the vehicle rear side portion of the first bracket 124, and the camera 122 is disposed at the inner side of the second bracket 126. The diameter of the vehicle rear side end portion of the inner surface of the second bracket 126 is enlarged via a step. A cover glass 128 that is plate-shaped is fit-together with an opening portion 126A of the vehicle rear side end portion of the second bracket 126. The cover glass 128 can transmit light therethrough, and closes-off the opening portion 126A of the vehicle rear side end portion of the second bracket 126. One surface of double-sided tape 127 is affixed to the outer peripheral portion of the vehicle front side of the cover glass 128 over the entire periphery thereof, and the outer peripheral side of another surface of the double-sided tape 127 is affixed to the step surface of the second bracket 126 over the entire periphery thereof. Further, a heater 129 that is sheet-shaped is adhered to the outer peripheral portion of the vehicle rear side of the cover glass 128 over the entire periphery thereof.

The visor rim 114 has a rear wall portion 114A that structures the vehicle rear side portion of the visor rim 114 and faces the vehicle rear side, and has a peripheral wall portion 114B that extends toward the vehicle front side from the rear wall portion 114A. The peripheral wall portion 114B is a substantial U-shape whose vehicle transverse direction inner side is open, as seen from the vehicle rear side (not shown). Further, a window 130 that is circular is formed so as to penetrate the rear wall portion 114A. An annular wall portion 132, which is tilted such that the diameter thereof increases from the peripheral end of the window 130 toward the vehicle rear side, is formed at the outer peripheral side of the window 130. The lens 122A of the camera 122 is disposed so as to face the exterior from the window 130, and the camera 122 captures images of the vehicle rear side via the window 130. The annular wall portion 132 structures the peripheral portion of the main surface side of the camera 122, and is disposed outside of the range of image angle A of the camera 122. Moreover, a portion of the above-described cover glass 128 is exposed from the window 130, and a recessed portion 133, which is recessed toward the vehicle front side with respect to a general portion 114A1 of the rear wall portion 114A, is formed by the annular wall portion 132 and the cover glass 128.

An opening portion 134 for projection/retraction of a nozzle 144 that is described later is formed so as to penetrate the annular wall portion 132. The opening portion 134 is formed further toward the vehicle upper side than the window 130. Further, a cover 136 that is made of resin is provided at the opening portion 134. The surface of the cover 136 forms a design surface that is continuous with the surface of the annular wall portion 132. A hinge shaft 137 is provided at the end portion, which is at the side far from the window 130, at the cover 136. The hinge shaft 137 extends substantially along the vehicle transverse direction, and the length direction both side regions of the hinge shaft 137 protrude-out from the cover 136. The hinge shaft 137 is supported so as to rotate freely at shaft supporting portions (not illustrated) that are provided at peripheral portions of the opening portion 134 of the visor rim 114. Due thereto, the cover 136 can rotate around the hinge shaft 137, and is disposed so as to cover the opening portion 134 so as to open/close the opening portion 134.

A spring mounting portion 114S is formed at the general portion 114A1 of the rear wall portion 114A at the reverse surface side of a peripheral portion of the Opening portion 134. One end of a plate spring 138 is mounted to this spring mounting portion 114S. The other end of the plate spring 138 is mounted to a spring mounting portion 136S that is formed at the reverse surface side of the cover 136. The plate spring 138 urges the cover 136 toward the closing position (the position shown in FIG. 8A).

A nozzle unit 142 is housed in the interior of the visor 112 at the vehicle upper side with respect to the camera unit 120. The nozzle unit 142 structures a portion of the washing device 140 and is provided in order to jet washing liquid toward the exposed portion of the cover glass 128 that is the object of washing in the present embodiment (in other words, toward the main surface side of the camera 122). A hose 149 is connected to the nozzle unit 142, and the pump P that is shown schematically in FIG. 7A is connected to the hose 149. The pump P feeds washing liquid that is stored in the tank T (illustrated schematically). Further, due to the pump P operating, washing liquid is supplied from the hose 149 shown in FIG. 8A to the nozzle unit 142. As an example, the nozzle unit 142 is structured to include the nozzle 144, a nozzle case 146, and a cover 148 for the nozzle case. Note that, in the drawings, the nozzle 144 is shown in a side view and not in cross-section.

The nozzle case 146 is fixed to the interior of the visor 112. The nozzle case 146 has a first tube portion 146A that is cylindrical tube shaped and structures the proximal portion side of the nozzle case 146, and a second tube portion 146B that structures the distal end portion side of the nozzle case 146 and whose inner diameter is smaller than that of the first tube portion 146A. The distal end portion of the first tube portion 146A and the proximal end portion of the second tube portion 14613 are connected via a step over the entire periphery. A cover main body 148A, which is a portion of the cover 148 for the nozzle case, is fixed so as to cover the proximal end side opening of the first tube portion 146A of the nozzle case 146. The cover main body portion 148A of the cover 148 for the nozzle case is formed in the shape of a short cylindrical tube having a bottom. A connecting tube portion 148B, which projects-out from the bottom portion of the cover main body 148A toward the opposite side from the nozzle case 146 side, is formed at the cover 148 for the nozzle case. One end portion of the hose 149 is connected to this connecting tube portion 148B, and, due thereto, washing liquid is supplied to the interior of the nozzle case 146.

The nozzle case 146 houses a portion of the nozzle 144. As shown in FIG. 8B, a bent portion 152 is formed at an intermediate portion of the nozzle 144, and the nozzle 144 is formed in a substantial L-shape on the whole. A portion 150 at the distal end portion side of the nozzle 144 is made able to project retract from the opening portion 134 (details described later). A jetting port 150A that jets-out the washing liquid is formed in the portion 150 at the distal end portion side of the nozzle 144. The check valve V, which opens in a case in which the pressure at the interior of the nozzle 144 exceeds a predetermined value, is provided at the portion 150 at the distal end portion side of the nozzle 144, and, due to the check valve V opening, washing liquid is jetted-out from the jetting port 150A. In the drawings, the direction in which the washing liquid is jetted-out is shown by arrow B.

A proximal portion 154, which is further toward the proximal end side than the bent portion 152 at the nozzle 144, has a proximal portion elongated tube portion 154A that is continuous with the bent portion 152 and whose inner diameter is set to be equal to that of the portion 150 at the distal end portion side. As shown in FIG. 8A, a tension spring 145 that serves as an urging member is housed at the interior of the proximal portion elongated tube portion 154A. One end of this tension spring 145 is connected to the proximal end side of the nozzle case 146, and another end is connected to the proximal portion elongated tube portion 154A. The tension spring 145 urges the nozzle 144 in the direction of a stored position 144X. Namely, in the non-operating state of the washing device 140, the nozzle 144 is pulled toward the proximal end side of the nozzle case 146 by the tension of the tension spring 145.

Further, as shown in FIG. 8B, the proximal portion 154 of the nozzle 144 has an enlarged diameter portion 154C whose diameter is enlarged from the proximal end side of the proximal portion elongated tube portion 154A via a step portion 154B, and that extends-out toward the proximal end side of the nozzle 144. The enlarged diameter portion 154C is formed in the shape of a short cylindrical tube, and the inner diameter thereof is larger than that of the proximal portion elongated tube portion 154A. The outer peripheral surface of the enlarged diameter portion 154C is disposed along the inner surface of the first tube portion 146A of the nozzle case 146. Further, as a result of the nozzle 144 being rotated and displaced around the axis of the proximal portion 154 from the state shown in FIG. 8A (the non-operating state of the washing device 140), as shown in FIG. 8B, the jetting port 150A is disposed so as to face the exposed portion side of the cover glass 128 (in other words, the main surface side of the camera 122).

The washing device 140 has an advancing/withdrawing rotating mechanism 158 that serves as both a rotating mechanism configured to rotate and displace the nozzle 144 around the axis of the proximal portion 154, and an advancing/withdrawing mechanism that moves the nozzle 144 to advance/withdraw along the axial direction of the proximal portion 154. The advancing/withdrawing rotating mechanism 158 in the present embodiment has a screw structure 158S that screws-together a male screw portion 154S, which is provided at the outer peripheral portion of the proximal portion 154 of the nozzle 144 (more concretely, at a portion of the proximal end side of the proximal portion elongated tube portion 154A), and a female screw portion 146S, which is provided at the inner peripheral portion of the nozzle case 146, and the advancing/withdrawing rotating mechanism 158 is structured to include the nozzle case 146 and the tension spring 145 (see FIG. 8A). Due thereto, the advancing/withdrawing rotating mechanism 158 is structured so as to rotate and displace the nozzle 144 around the axis of the proximal portion 154, while moving the nozzle 144 to advance/withdraw along the axial direction of the proximal portion 154. Further, by using the force of the nozzle 144 being displaced, the advancing/withdrawing rotating mechanism 158 displaces the cover 136 in a direction that is different than the direction in which the nozzle 144 is displaced so as to open/close the cover 136. Here, the advancing/withdrawing rotating mechanism 158 opens/closes the cover 136 by using the force of the nozzle 144 being rotated and displaced.

(Operation/Effects)

Operation and effects of the present embodiment are described next.

In the present embodiment, viewing by an occupant of the vehicle is assisted by the camera 122 that is housed in the visor 112 shown in FIG. 8A. Further, in a case in which the exposed portion of the cover glass 128 of the main surface side of the camera 122 is dirty, due to the pump P (see FIG. 1) operating automatically or manually, the washing device 140 that washes the exposed portion of the cover glass 128 operates. Then, the washing liquid is jetted-out from the nozzle 144 toward the exposed portion of the cover glass 128 of the main surface side of the camera 122. Here, the nozzle 144 is disposed such that, by being rotated and displaced from the state shown in FIG. 8A around the axis of the proximal portion 154 as is shown in FIG. 8B, the jelling port 150A faces the exposed portion side of the cover glass 128. Due thereto, the nozzle 144 is rotated and displaced around the axis of the proximal portion 154 by the advancing/withdrawing rotating mechanism 158. Further, by using the force of the nozzle 144 being displaced, the advancing/withdrawing rotating mechanism 158 displaces the cover 136 in a direction that is different from the direction in which the nozzle 144 is displaced so as to open/close the cover 136. Here, the advancing/withdrawing rotating mechanism 158 opens/closes the cover 136 by using the force of the nozzle 144 being rotated and displaced. Therefore, enlarging of the space at the periphery of the stored position 144X of the nozzle 144 (see FIG. 8A) is suppressed.

To describe this further, for example, in a comparative structure in which a nozzle is simply moved so as to advance/withdraw in a posture that is similar to that of the nozzle 144 (without being rotated and displaced), when the nozzle, which is at a similar position as the nozzle 144 shown in FIG. 8B, merely withdraws, a portion of the distal end portion side of the nozzle interferes with peripheral structures. Therefore, in the case of the above-described comparative structure, the position of the nozzle must be shifted in a direction of moving away from the camera unit (120), and the upper wall portion position of the peripheral wall portion (114B) of the visor rim (114) must be shifted toward the upper side. In such a structure, the space at the periphery of the nozzle storage position is enlarged. In contrast, in the present embodiment, as a result of the nozzle 144 being rotated and displaced around the axis of the proximal portion 154, interference with peripheral structures is avoided, and enlarging of the space at the periphery of the stored position 144X of the nozzle 144 (see FIG. 8A) is suppressed.

Further, in the present embodiment, the advancing/withdrawing rotating mechanism 158 serves as both a rotating mechanism and an advancing/withdrawing mechanism, and the nozzle 144 is rotated and displaced around the axis of the proximal portion 154 while being moved so as to advance/withdraw along the axial direction of the proximal portion 154, by the advancing/withdrawing rotating mechanism 158. Due thereto, a new variation of the locus of movement of the nozzle 144 can be provided, and a new variation for avoiding interference between the nozzle 144 and peripheral structures can be provided.

Further, in the present embodiment, as shown in FIG. 8A, in a state in which a portion of the nozzle 144 is accommodated in the nozzle case 146, the nozzle 144 is urged in the direction of the stored position 144X by the tension spring 145, and washing liquid is supplied to the nozzle case 146. Here, the male screw portion 154S is provided at the outer peripheral portion of the proximal portion 154 of the nozzle 144, and the female screw portion 146S is provided at the inner peripheral portion of the nozzle case 146, and the screw structure 158S that screws these together is provided. Due thereto, when washing liquid is supplied to the nozzle case 146, and the nozzle 144 is pushed against the urging force of the tension spring 145, as shown in FIG. 8B, the nozzle 144 is rotated and displaced around the axis of the proximal portion 154 while advancing along the axial direction of the proximal portion 154. Further, when 1 supply of the washing liquid to the nozzle case 146 is stopped, the nozzle 144 that receives the urging force of the tension spring 145 is rotated and displaced around the axis of the proximal portion 154 while withdrawing along the axial direction of the proximal portion 54, and returns to the stored position 144X shown in FIG. 8A.

In this way, in the present embodiment, the nozzle 144 is displaced by the screw structure 158S while the washing liquid is used as motive power, and further, the urging force of the tension spring 145 shown in FIG. 8A is utilized. Therefore, an increase in the size of the structural portions that displace the nozzle 144 can be suppressed, and the space for housing such structural portions can be kept small.

As described above, in accordance with the viewing device 111 for a vehicle of the present embodiment, the space that is needed in order to house and move the nozzle 144 can be kept small even if the intermediate portion of the nozzle 144 is bent.

### Fifth Embodiment

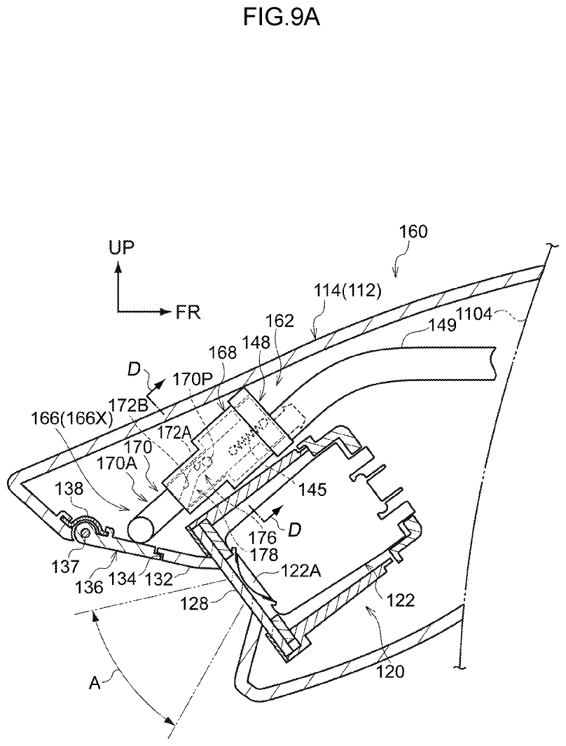

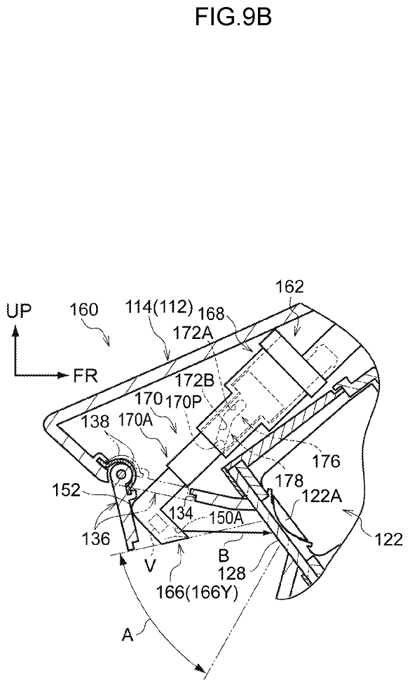

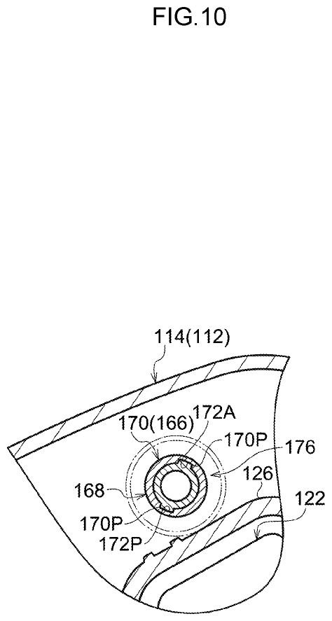

A viewing device for a vehicle relating to a fifth embodiment of the present invention is described by using FIG. 3A through FIG. 9B. The non-operating state of a washing device 162 of a viewing device 160 for a vehicle relating to the present embodiment is shown in FIG. 9A in a cross-sectional view of a state that is cut at a similar cutting position as FIG. 8A. The operating state of the washing device 162 is shown in a cross-sectional view in FIG. 9B. Note that, in FIG. 9A and FIG. 9B, the washing device 162 is shown in a side view and not in cross-section. Further, an enlarged sectional view, in which the state cut along line D-D of FIG. 9A is enlarged, is shown in FIG. 10.

As shown in these drawings, the viewing device 160 for a vehicle relating to the present embodiment differs from the viewing device 111 for a vehicle relating to the fourth embodiment (see FIG. 8A) with regard to the point of having a first mechanism 176 that serves as an advancing/withdrawing mechanism and a second mechanism 178 that serves as a rotating mechanism and advancing/withdrawing mechanism, instead of the advancing/withdrawing rotating mechanism 158 of the fourth embodiment (see FIG. 8A). The other structures are structures that are substantially similar to those of the fourth embodiment. Accordingly, structural portions that are substantially similar to those of the fourth embodiment are denoted by the same reference numerals, and description thereof is omitted.

A nozzle 166 in the present embodiment is structured similarly to the nozzle 144 of the fourth embodiment (see FIG. 8A) except for the point of not having the male screw portion 154S of the fourth embodiment (see FIG. 8A), and the point of having a portion that structures a portion of the first mechanism 176 and a portion of the second mechanism 178. The nozzle 166 is made of resin. Further, a nozzle case 168 in the present embodiment is structured similarly to the nozzle case 146 of the fourth embodiment (see FIG. 8A) except for the point of not having the female screw portion 146S of the fourth embodiment (see FIG. 8A). and the point of having a portion that structures a portion of the first mechanism 176 and a portion of the second mechanism 178. The nozzle case 168 is made of resin.

As shown in FIG. 9B, a proximal portion 170, which is further toward the proximal end side than the bent portion 152 at the nozzle 166, has, instead of the proximal portion elongated tube portion 154A of the fourth embodiment (see FIG. 8B), a proximal portion elongated tube portion 170A that does not have the male screw portion 154S (see FIG. 8B). A shaft portion 170P stands erect from the outer peripheral surface of a length direction intermediate portion of the proximal portion elongated tube portion 170A of the present embodiment.

In contrast, a first guiding portion 172A and a second guiding portion 172B are provided, instead of the female screw portion 146S of the fourth embodiment (see FIG. 8B), at the nozzle case 168 that accommodates a portion of the nozzle 166. The first guiding portion 172A is a guide rail portion that is formed at the nozzle case 168, rectilinearly along the axial direction of the proximal portion 170 of the nozzle 166, and guides the shaft portion 170P of the nozzle 166. Further, the second guiding portion 172B is a guide rail portion that is formed at the nozzle case 168 continuously with the distal end of the first guiding portion 172A so as to form a portion of a spiral, and guides the shaft portion 170P of the nozzle 166.

In the present embodiment, the first mechanism 176 has the above-described shaft portion 170P and first guiding portion 172A, and is structured to include the nozzle case 168 and the tension spring 145 (see FIG. 9A). Due thereto, the first mechanism 176 is structured so as to move the nozzle 166 to advance/withdraw along the axial direction of the proximal portion 170 and in a state in which the posture thereof at a stored position 166X is maintained, between the stored position 166X (see FIG. 9A) at which the nozzle 166 is stored and an intermediate reference position that is a position that is advanced further than the stored position 166X and is a position that is set in advance (a position that is advanced further than the stored position 166X by an amount corresponding to the length of the first guiding portion 172 in the guiding direction).

The second mechanism 178 of the present embodiment has the above-described shaft portion 170P and second guiding portion 172B, and is structured to include the nozzle case 168 and the tension spring 145 (see FIG. 9A). Due thereto, the second mechanism 178 serves as both a rotating mechanism configured to rotate and displace the nozzle 166 around the axis of the proximal portion 170, and an advancing/withdrawing mechanism that moves the nozzle 166 so as to advance/withdraw along the axial direction of the proximal portion 170. Further, the second mechanism 178 is structured so as to rotate and displace the nozzle 166 around the axis of the proximal portion 170 while moving the nozzle 166 to advance/withdraw along the axial direction of the proximal portion 170, between the aforementioned intermediate reference position and a jetting position 166Y (see FIG. 9B) that is the position at which the nozzle 166 jets-out the washing liquid. Further, by using the force of the nozzle 166 being displaced, the second mechanism 178 displaces the cover 136 in a direction that is different than the direction in which the nozzle 166 is displaced so as to open/close the cover 136. Here, the second mechanism 178 opens/closes the cover 136 by using the force of the nozzle 166 being rotated and displaced.

In accordance with the present embodiment, as shown in FIG. 9A, the nozzle 166 is urged in the direction of the stored position 166X by the tension spring 145 in a state in which a portion of the nozzle 166 is accommodated in the nozzle case 168, and washing liquid is supplied to the nozzle case 168. The shaft portion 170P, which stands erect from the outer peripheral surface of the proximal portion 170 of the nozzle 166, is guided along the axial direction of the proximal portion 170 of the nozzle 166 by the first guiding portion 172A that is formed at the nozzle case 168. Further, the shaft portion 170P is guided by the second guiding portion 172B that is continuous with the distal end of the first guiding portion 172A at the nozzle case 168 and that is formed so as to form a portion of a spiral.

Due thereto, when washing liquid is supplied to the nozzle case 168, and the nozzle 166 is pushed, the nozzle 166 advances along the axial direction of the proximal portion 170 due to the first mechanism 176 in a state in which the posture of the nozzle 166 at the time of storage is maintained, and thereafter, is rotated and displaced around the axis of the proximal portion 170 while advancing along the axial direction of the proximal portion 170 due to the second mechanism 178, and is disposed at the jetting position 166Y shown in FIG. 9B. Further, when the supply of washing liquid to the nozzle case 168 is stopped, the nozzle 166 that receives the urging force of the tension spring 145 (see FIG. 9A) is rotated and displaced around the axis of the proximal portion 170 while withdrawing along the axial direction of the proximal portion 170 due to the second mechanism 178, and thereafter, withdraws along the axial direction of the proximal portion 170 due to the first mechanism 176, and is disposed at the stored position 166X shown in FIG. 9A. In this way, in the present embodiment, a new variation of the locus of movement of the nozzle 166 can be provided, and a new variation for avoiding interference between the nozzle 166 and peripheral structures can be provided. Further, as a result of the nozzle 166 being rotated and displaced around the axis of the proximal portion 170 by the second mechanism 178, enlargement of the space at the periphery of the stored position 166X of the nozzle 166 is suppressed.

Further, in the present embodiment, the nozzle 166 is displaced by using the shaft portion 170P, the first guiding portion 172A and the second guiding portion 172B, while the washing liquid is used as motive power, and further, the urging force of the tension spring 145 is utilized. Therefore, an increase in size of the structural portions that displace the nozzle 166 can be suppressed, and the space for housing such structural portions can be kept small.

In accordance with the viewing device 160 for a vehicle of the present embodiment that is described above, the space that is needed in order to house and move the nozzle 166 can be kept small even if an intermediate portion of the nozzle 166 is bent.

### Sixth Embodiment

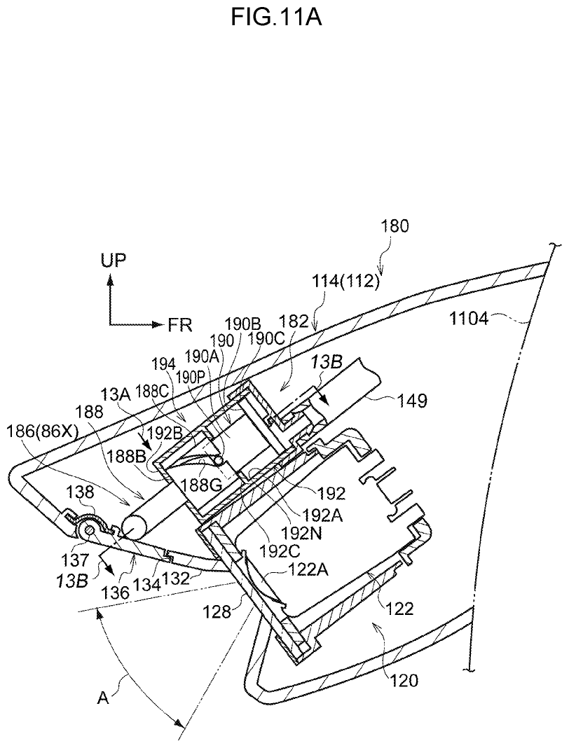

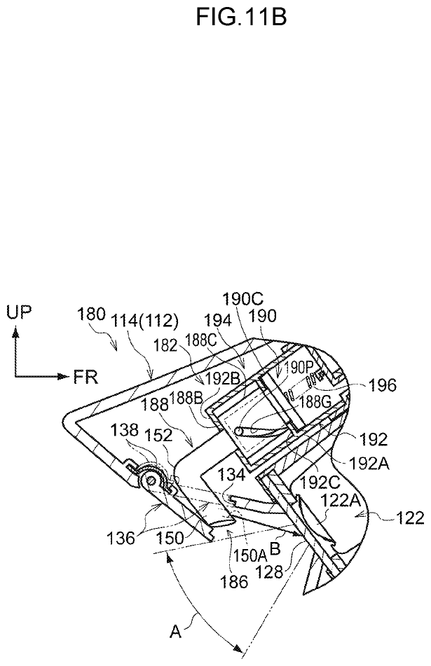

A viewing device for a vehicle relating to a sixth embodiment of the present invention is described by using FIG. 11A through FIG. 13B. The non-operating state of a washing device 182 of a viewing device 180 for a vehicle relating to the present embodiment is shown in FIG. 1A in a cross-sectional view of a state that is cut at a similar cutting position as FIG. 8A. The operating state of the washing device 182 is shown in a cross-sectional view in FIG. 11B. Note that, in FIG. 11A and FIG. 11B, portions of the washing device 182 (concretely, a nozzle 186 and a part 190 for nozzle rotation that serves as a tubular body) are shown in a side view and not in cross-section.

As shown in these drawings, the viewing device 180 for a vehicle relating to the present embodiment differs from the viewing device 111 for a vehicle relating to the fourth embodiment (see FIG. 8A) with regard to the point of having a rotating mechanism 194, instead of the advancing/withdrawing rotating mechanism 158 of the fourth embodiment (see Fiu. 8A). The other structures are structures that are substantially similar to those of the fourth embodiment. Accordingly, structural portions that are substantially similar to those of the fourth embodiment are denoted by the same reference numerals, and description thereof is omitted.

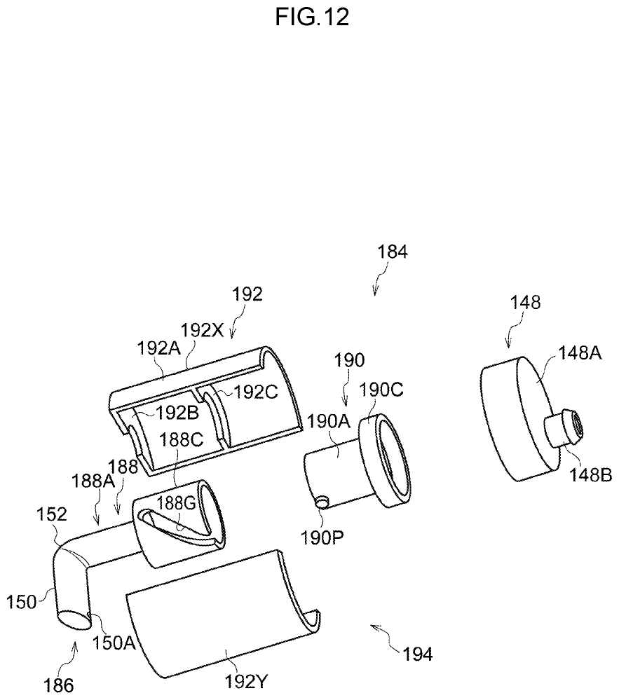

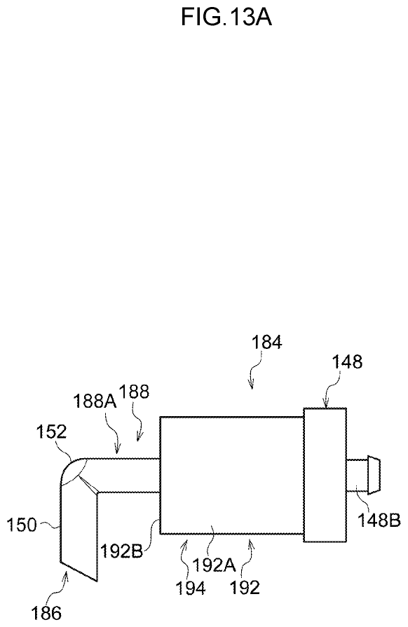

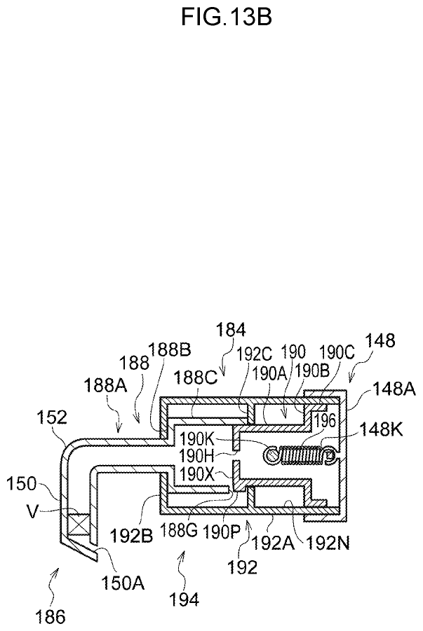

In FIG. 12, an exploded perspective view in which a nozzle unit 184 of the present embodiment is exploded is shown (a tension spring 196 (see FIG. 13B) that serves as an uruing member and is described later is not illustrated). A drawing of state that is enlarged and seen from the direction of arrow 13A of FIG. 11A is shown in FIG. 13A, and a cross-sectional view of a state that is enlarged and is cut along line 13B-13B of FIG. 11A is shown in FIG. 13B. The check valve V is illustrated in a simplified manner in FIG. 13B. Further, the nozzle unit 184 is made of resin. As shown in FIG. 12 through FIG. 13B, the nozzle 186 has the bent portion 152 and the portion 150 at the distal end side that are substantially similar to those of the fourth embodiment. Further, instead of the proximal portion elongated tube portion 154A of the nozzle 144 (refer to FIG. 8B for both) of the fourth embodiment, the nozzle 186 has a proximal portion elongated tube portion 188A that does not have the male screw portion 154S (see FIG. 8B). The inner diameter and the outer diameter of the proximal portion elongated tube portion 188A are set to be equal to those of the portion 150 at the distal end side of the nozzle 186.

Further, as shown in FIG. 13B, a first enlarged diameter portion 188C, which is tubular and whose diameter is enlarged via a first step portion 188B, extends at the proximal end side of the nozzle 186 from an axial direction intermediate portion of a proximal portion 188 of the nozzle 186 (more concretely, the proximal end of the proximal portion elongated tube portion 188A).

Further, as shown in FIG. 12 and FIG. 13B, the nozzle unit 184 has the part 190 for nozzle rotation. As shown in FIG. 13B, the tension spring 196 is housed in the interior of the part 190 for nozzle rotation. One end of this tension spring 196 is anchored on a spring anchoring portion 148K that is hook-shaped and is formed at the proximal end side of the cover 148 for the nozzle case. The another end of the tension spring 196 is anchored on a spring anchoring portion 190K that spans across the inner side of the part 190 for nozzle rotation. In the non-operating state of the washing device 182 (see FIG. 11A), the part 190 for nozzle rotation is pulled toward the proximal end side of the cover 148 for the nozzle case by the tension of the tension spring 196. Further, the tension spring 196 also has the function of suppressing rotation of the part 190 for nozzle rotation around its own axis.

The part 190 for nozzle rotation has an inserted tube portion 190A that is inserted in the first enlarged diameter portion 188C of the nozzle 186. The above-described tension spring 196 urges the part 190 for nozzle rotation in the direction of decreasing the inserted amount of the inserted tube portion 190A in the first enlarged diameter portion 188C of the nozzle 186. A pressure receiving wall portion 190X, which extends-out toward the radial direction inner side of the inserted tube portion 190A from a region at the insertion distal end side, is formed at the inserted tube portion 190A. The pressure receiving wall portion 190X is the region that receives the liquid pressure of the washing liquid, and a through-hole 190H is formed therein. The through-hole 190H is, as an example, formed in the central portion of the pressure receiving wall portion 190X, and the inner diameter of the through-hole 190H is, as an example, set to be smaller than the inner diameter of the proximal portion elongated tube portion 188A. Further, the part 190 for nozzle rotation has a second enlarged diameter portion 190C that is tubular, and whose diameter is enlarged via a second step portion 190B from the end portion, which is at the opposite side from the insertion distal end side, at the inserted tube portion 190A, and that extends at the opposite side from the outer peripheral space side of the inserted tube portion 190A (in other words, at the bottom portion side of the cover main body 148A of the cover 148 for the nozzle case). The second enlarged diameter portion 190C is formed in the shape of a short cylindrical tube, and the inner diameter thereof is larger than that of the inserted tube portion 190A, and the outer diameter thereof is larger than that of the first enlarged diameter portion 1880 of the nozzle 186.

Further, the nozzle unit 184 has a nozzle case 192 to which washing liquid is supplied. Note that the nozzle case 192 is, as an example, structured by plural structural parts 192X, 192Y that are shown in FIG. 12 being joined. As shown in FIG. 13A, the nozzle case 192 has a case tube portion 192A that is formed in a tubular shape. The case tube portion 192A houses the first step portion 188B and the first enlarged diameter portion 188C of the nozzle 186, and the part 190 for nozzle rotation, which are shown in FIG. 13B. Inner peripheral surface 192N of the case tube portion 192A is configured to not contact the outer peripheral surface of the first enlarged diameter portion 188C of the nozzle 186, and contact the outer peripheral surface of the second enlarged diameter portion 190C of the part 190 for nozzle rotation.

The nozzle case 192 has a distal end wall portion 192B that serves as a distal end side wall portion and extends-out toward the radial direction inner side of the case tube portion 192A from a portion of the distal end side of the case tube portion 192. A The proximal portion elongated tube portion 188A passes-through this distal end wall portion 192B, and the inner diameter of the distal end wall portion 192B is set to be equal to (strictly speaking, very slightly larger than) the outer diameter of the proximal portion elongated tube portion 188A of the nozzle 186. The first step portion 188B of the nozzle 186 is disposed in a state of contacting the distal end wall portion 192B. Further, the nozzle case 192 has a restricting wall portion 192C that serves as a restricting portion that extends-out toward the radial direction inner side of the case tube portion 192A from an axial direction intermediate portion of the case tube portion 192A. The restricting wall portion 192C is formed in an annular shape as seen from the axial direction of the case tube portion 192A, and the inner diameter of the restricting wall portion 192C is set to be equal to the inner diameter of the first enlarged diameter portion 188C of the nozzle 186. The proximal end surface of the first enlarged diameter portion 188C of the nozzle 186 is disposed in a state of contacting the restricting wall portion 192C. Namely, the restricting wall portion 192C is configured to restrict the movement of the first enlarged diameter portion 188C of the nozzle 186 toward the opposite side from the distal end wall portion 192B side.

On the other hand, as shown in FIG. 12, a shaft portion 190P stands erect from the outer peripheral surface of a portion of the distal end portion side of the inserted tube portion 190A. Further, a guiding portion 188G that accommodates and guides the shaft portion 190P is formed so as to penetrate the first enlarged diameter portion 188C of the nozzle 186, so as to form a portion of a spiral. The guiding portion 188G is configured to rotate and displace the first enlarged diameter portion 188C around the axis of the proximal portion 188, in a case in which the guiding portion 188G is pushed by the shaft portion 190P in the axial direction of the proximal portion 188. Further, the rotating mechanism 194 of the present embodiment has the above-described shaft portion 190P and guiding portion 188G, and is structured to include the first step portion 188B and the first enlarged diameter portion 188C of the nozzle 186, the part 190 for nozzle rotation, the nozzle case 192 and the tension spring 196 that are shown in FIG. 13A. Further, by using the force of the nozzle 186 being displaced, the rotating mechanism 194 displaces the cover 136 in a direction that is different from the direction in which the nozzle 186 is displaced so as to open/close the cover 136. Here, the rotating mechanism 194 opens/closes the cover 136 by using the force of the nozzle 186 being rotated and displaced.

Operation and effects of the present embodiment are described next.

In the present embodiment, as shown in FIG. 13B, the first step portion 188B of the nozzle 186 is disposed in a state of contacting the distal end wall portion 192B of the nozzle case 192, and the restricting wall portion 192C restricts movement of the first enlarged diameter portion 188C of the nozzle 186 toward the opposite side from the distal end wall portion 192B side. Accordingly, movement of the first step portion 186B and the first enlarged diameter portion 188C in a direction running along the axial direction of the proximal portion 188 is not possible, and rotation and displacement thereof around the axis of the proximal portion 188 are possible.

Further, in the present embodiment, the inserted tube portion 190A of the part 190 for nozzle rotation is inserted in the first enlarged diameter portion 188C of the nozzle 186. Further, because the outer peripheral surface of the second enlarged diameter portion 190C of the part 190 for nozzle rotation contacts the inner peripheral surface of the case tube portion 192. A of the nozzle case 192, in a case in which the part 190 for nozzle rotation advances along the axial direction thereof due to the liquid force of the washing liquid, the part 190 for nozzle rotation can move stably. Further, the part 190 for nozzle rotation is urged by the tension spring 196 in the direction of decreasing the inserted amount of the inserted tube portion 190A in the first enlarged diameter portion 188C, and rotation around the axis of the part 190 for nozzle rotation is suppressed by the tension spring 196.

Further, as shown in FIG. 11A, the shaft portion 190P stands erect from the outer peripheral surface of a portion of the distal end portion side of the inserted tube portion 190A. The guiding portion 188G is configured to rotate and displace the first enlarged diameter portion 188C around the axis of the proximal portion 188 in a case in which the guiding portion 188C, which is formed so as to form a portion of a spiral at the first enlarged diameter portion 188C of the nozzle 186, is pushed by the shaft portion 190P. Due thereto, when washing liquid is supplied to the nozzle case 192, and the part 190 for nozzle rotation advances against the urging force of the tension spring 196 (see FIG. 13B), the shaft portion 190P of the part 190 for nozzle rotation pushes the guiding portion 188C of the nozzle 186, and, as shown in FIG. 11B, the nozzle 186 is rotated and displaced around the axis of the proximal portion 188, without the position in the axial direction of the proximal portion 188 changing. Further, by using the force of the nozzle 186 being displaced, the rotating mechanism 194 displaces the cover 136 in a direction that is different than the direction in which the nozzle 186 is displaced so as to open/close the cover 136. Here, the rotating mechanism opens/closes the cover 136 by using the force of the nozzle 186 being rotated and displaced. At this time, the cover 136 is pushed by the portion 150 at the distal end side of the nozzle 186 and is opened. In accordance with the present embodiment, the space at the periphery of the stored position 186X of the nozzle 186 can be made to be small due to the nozzle 186 not stroking.

Further, when supply of washing liquid to the nozzle case 192 is stopped, the part 190 for nozzle rotation that receives the urging force of the tension spring 196 withdraws. Therefore, the shaft portion 190P of the part 190 for nozzle rotation pushes the guiding portion 188G of the nozzle 186, and the nozzle 186 is rotated and displaced around the axis of the proximal portion 188 without the position in the axial direction of the proximal portion 188 changing, and the nozzle 186 returns to the stored position 186X shown in FIG. 11A. At this time, the cover 136 is closed by the urging force of the plate spring 138.

In this way, in the present embodiment, the nozzle 186 is displaced by using the above-described rotating mechanism 194, while the washing liquid is used as motive power, and further, the urging force of the tension spring 196 is utilized. Therefore, an increase in the size of the structural portions that displace the nozzle 186 can be suppressed, and the space for housing such structural portions can be kept small.

As described above, in accordance with the present embodiment, the space that is needed in order to house and move the nozzle 186 can be kept small even if an intermediate portion of the nozzle 186 is bent.

### Modified Examples of Embodiments

Note that, aithouch the viewing assistance portion is the camera 122 in the above-described embodiments, the viewing assistance portion may be another viewing assistance portion such as a mirror or the like for example.

As a modified example of the above-described fourth and fifth embodiments, there may be a structure in which a compression spring is used as the urging member for urging the nozzle (144, 166) in the direction of the stored position thereof (144X, 166X). Further, as a modified example of the above-described sixth embodiment, there may be a structure in which a compression spring is used as an urging member that urges the part (190) for nozzle rotation in the direction of decreasing the inserted amount of the inserted tube portion (190A) of the part (190) for nozzle rotation in the first enlarged diameter portion (188C) of the nozzle (186), and that is for suppressing rotation of the part (190) for nozzle rotation around the axis thereof.

Although examples of the present disclosure have been described above, the present disclosure is not limited to the above, and can, of course, be implemented by being modified various ways other than the above, within a scope that does not depart from the gist thereof.

Note that the disclosures of Japanese Patent Application No. 2019-094678 filed on May 20, 2019 and Japanese Patent Application No. 2019-094673 filed on May 20, 2019 are, in their entireties, incorporated by reference into the present specification. All publications, patent applications, and technical standards mentioned in the present specification are incorporated by reference into the present specification to the same extent as if such individual publication, patent application, or technical standard was specifically and individually indicated to be incorporated by reference.

1. A viewing device for a vehicle, comprising:
a viewing assistance portion provided at a vehicle and configured to assist viewing by an occupant of the vehicle;
a panel member configuring a portion of a housing body that houses the viewing assistance portion, and in which an opening portion for nozzle projection/retraction is formed so as to penetrate at a peripheral portion of a main surface side of the viewing assistance portion;
a nozzle that is housed in the housing body and displaced so as to project/retract from the opening portion, and that, in a state of projecting out from the opening portion, jets washing liquid from a jetting port at a distal end portion side of the nozzle toward a main surface side of the viewing assistance portion;
a cover that is displaced between a closing position at which the opening portion is closed and an opening position that is provided at a side that is farther from a main surface of the viewing assistance portion than the closing position, to perform opening and closing; and
a mechanism that, using a force of the nozzle being displaced, displaces the cover in a different direction from a direction in which the nozzle is displaced so as to open/close the cover.

2. The viewing device for a vehicle of claim 1, wherein the mechanism is an interlocking mechanism configured to slide the cover from the closing position to the opening position by using a force of the nozzle advancing to a position projecting out from the opening portion.

3. The viewing device for a vehicle of claim 2, wherein the interlocking mechanism connects the nozzle and the cover, and also has a function of sliding the cover from the opening position to the closing position by using a force of the nozzle which is in a state of projecting out from the opening portion, retracting.

4. The viewing device for a vehicle of claim 2, comprising an urging member that urges the cover in a direction of the closing position.

5. The viewing device for a vehicle of claim 3, wherein the interlocking mechanism comprises:
a shaft portion provided at the cover; and
a guiding portion provided at the nozzle, the guiding portion being configured to guide the shaft portion such that the cover slides and is opened/closed in accordance with movement of the nozzle in a projecting/retracting direction.

6. The viewing device for a vehicle of claim 3, wherein the interlocking mechanism comprises:
a shaft portion provided at the nozzle; and
a guiding portion provided at the cover, the guiding portion being configured to guide the shaft portion and to slide and open/close the cover by receiving a load from the shaft portion in accordance with movement of the nozzle in a projecting/retracting direction.

7. The viewing device for a vehicle of claim 1, wherein:
the mechanism is a rotating mechanism configured to rotate and displace the nozzle around an axis of a proximal portion,
a bent portion is formed at an intermediate portion of the nozzle, and the nozzle is disposed such that the jetting port faces the main surface side of the viewing assistance portion as a result of the nozzle being rotated and displaced, by the rotating mechanism, around the axis of the proximal portion that is further toward a proximal end side than the bent portion, and
the cover is rotated and displaced from the closing position to the opening position by the rotating mechanism by using a force of the nozzle being rotated and displaced.

8. The viewing device for a vehicle of claim 7, comprising an advancing/withdrawing mechanism configured to move the nozzle so as to advance/withdraw along an axial direction of the proximal portion.

9. The viewing device for a vehicle of claim 8, wherein the rotating mechanism is an advancing/withdrawing rotating mechanism that also serves as the advancing/withdrawing mechanism and that rotates and displaces the nozzle around the axis of the proximal portion while moving the nozzle to advance/withdraw along the axial direction of the proximal portion.

10. The viewing device for a vehicle of claim 8, wherein the advancing/withdrawing mechanism comprises:
a first mechanism that moves the nozzle so as to advance/withdraw along the axial direction of the proximal portion in a state in which a posture al a stored position is maintained, between the stored position at which the nozzle is stored and an intermediate reference position, which is a position at which the nozzle is advanced further than the stored position and is a position that is set in advance; and
a second mechanism that also serves as the rotating mechanism and that rotates and displaces the nozzle around the axis of the proximal portion while moving the nozzle to advance/withdraw along the axial direction of the proximal portion, between the intermediate reference position and a jetting position that is a position at which the nozzle jets out washing liquid.

9. The viewing device for a vehicle of claim 9, wherein the advancing/withdrawing rotating mechanism has:
a nozzle case that accommodates a portion of the nozzle and to which washing liquid is supplied;
an urging member that urges the nozzle in a direction of the stored position; and
a screw structure comprising screw portions provided at an outer peripheral portion of the proximal portion of the nozzle and an inner peripheral portion of the nozzle case, respectively, with the screw portions screwed together.

10. viewing device for a vehicle of claim 10, wherein: the first mechanism includes:
a nozzle case that accommodates a portion of the nozzle and to which washing liquid is supplied,
an urging member that urges the nozzle in a direction of the stored position,
a shaft portion that stands erect from an outer peripheral surface of the proximal portion of the nozzle, and
a first guiding portion that is formed at the nozzle case, rectilinearly along the axial direction of the proximal portion of the nozzle, and that guides the shaft portion; and
the second mechanism includes:
the nozzle case,
the urging member,
the shaft portion, and
a second guiding portion that is formed at the nozzle case continuously with a distal end of the first guiding portion and so as to form a portion of a spiral, and that guides the shaft portion.

13. The viewing device for a vehicle of claim 7, wherein the rotating mechanism has:
a first enlarged diameter portion that is tubular, that has a diameter enlarged via a first step portion from an axial direction intermediate portion of the proximal portion of the nozzle, and that extends at a proximal end side of the nozzle;
a tubular body having an inserted tube portion that is inserted in the first enlarged diameter portion of the nozzle, and a second enlarged diameter portion that is tubular, that has a diameter enlarged via a second step portion from an end portion at an opposite side from an insertion distal end side at the inserted tube portion, and that extends at an opposite side from an outer peripheral space side of the inserted tube portion;
a nozzle case to which washing liquid is supplied, that has a case tube portion formed in a tubular shape, that houses the first step portion, the first enlarged diameter portion and the tubular body, that is configured such that an inner peripheral surface thereof contacts an outer peripheral surface of the second enlarged diameter portion, that has a distal end side wall portion that extends toward a radial direction inner side of the case tube portion from a portion of a distal end side of the case tube portion, and that is disposed in a state of being contacted by the first step portion;
a restricting portion that restricts movement of the first enlarged diameter portion toward an opposite side from the distal end side wall portion;
an urging member that urges the tubular body in a direction of decreasing an inserted amount of the inserted tube portion in the first enlarged diameter portion, and that suppresses rotation of the tubular body around its own axis;
a shaft portion that stands erect from an outer peripheral surface of a portion of a distal end portion side of the inserted tube portion; and
a guiding portion that is formed at the first enlarged diameter portion of the nozzle so as to form a portion of a spiral, that guides the shaft portion, and that is configured to, in a case of being pushed in an axial direction of the proximal portion by the shaft portion, rotate and displace the first enlarged diameter portion around the axis of the proximal portion.
